(19) United States
(12) Patent Application Publication
(10) Pub. No.: US 2018/0137945 A1
(43) Pub. Date: May 17, 2018

(54) SYSTEMS AND METHODS FOR ASSAYING NUCLEAR FUEL

(71) Applicant: BATTELLE ENERGY ALLIANCE, LLC, IDAHO FALLS, ID (US)

(72) Inventors: DAVID L. CHICHESTER, IDAHO FALLS, ID (US); SCOTT J. THOMPSON, AMMON, ID (US); JAMES T. JOHNSON, RIGBY, ID (US); JEFFREY D. SANDERS, IDAHO FALLS, ID (US); SCOTT M. WATSON, IDAHO FALLS, ID (US)

(21) Appl. No.: 15/349,654

(22) Filed: Nov. 11, 2016

(51) Int. Cl. G21C 17/06; G01T 3/06

(52) U.S. Cl. CPC G21C 17/06; G01T 3/06

(57) ABSTRACT

A nuclear fuel assay system comprises a nuclear fuel assembly comprising structures containing nuclear fuel, and a neutron collar surrounding sides of the nuclear fuel assembly and comprising pressurized ⁴He scintillation detectors. A system for assaying nuclear fuel, and a method of quantifying nuclear material are also described.

### STATEMENT REGARDING FEDERALLY SPONSORED RESEARCH OR DEVELOPMENT

This invention was made with government support under Contract Number DE-AC07-05ID14517 awarded by the United States Department of Energy. The government has certain rights in the invention.

### TECHNICAL FIELD

The disclosure, in various embodiments, relates generally to systems and methods for assaying nuclear fuel. More specifically, embodiments of the disclosure relate to systems including arrangements of helium-4 scintillation detectors configured and operated to directly measure fast, fission-spectrum neutrons, and to related methods.

### BACKGROUND

Control of nuclear proliferation presents a continuing need for systems and methods of accounting for nuclear material (e.g., special nuclear material (SNM), such as uranium-containing materials, plutonium-containing materials, etc.) inventories. The ability to determine the quantity of nuclear material present within an assembly (e.g., a nuclear fuel assembly, a containment assembly, etc.) is critical to nuclear material accountancy. Such determinations are necessary to verify nuclear material inventory declarations and ensure conformity with nuclear safeguards.

One method of determining the quantity of nuclear material present within a given assembly includes performing a paired set of measurements employing gamma-ray spectroscopy and time-correlated neutron emission analysis to determine the mass of the nuclear material. The gamma-ray data is used to determine the isotopic content of the nuclear material, which is then utilized to interpret the time-correlated neutron data and deduce the mass of the nuclear material.

Various time-correlated neutron measurement systems have been produced for nuclear material accountancy. Such measurement systems typically include arrangements (e.g., collars) of neutron detectors that receive and quantify (e.g., count) neutrons produced by a nuclear material through one or more of spontaneous fission and induced fission. Measurement systems designed to detect and quantify single and double neutron coincidence events (e.g., first and second factorial moments in an observed multiplicity distribution) are generally referred to as “coincidence counting” systems, while measurement systems designed to detect and quantify single, double, and higher-order (e.g., triple) neutron coincidence events (e.g., first, second, and third factorial moments in an observed multiplicity distribution) are generally referred as “multiplicity counting” systems.

Many conventional time-correlated neutron measurement systems perform neutron multiplicity measurements using moderated helium-3 (³He) proportional counters surrounding sides of an assembly containing nuclear material. The ³He proportional counters employ ³He gas as a neutron detection medium, and are at least partially surrounded by a moderator material (e.g., high-density polyethylene) that thermalizes (e.g., reduces the average fission energy of) neutrons produced by the nuclear material to generate thermal and/or epithermal neutrons (e.g., neutrons having a neutron energy level within a range of from 0.025 electronvolt (eV) to 0.4 eV) that the ³He proportional counters can efficiently detect. However, ³He gas is now of limited and dwindling supply world-wide, rendering the long term use of ³He proportional counters unfeasible. In addition, the thermalization processes required by moderated ³He proportional counters occurs over tens of microseconds (μs) or longer, and can undesirably obscure any direct energy or timing information from the neutrons generated by the nuclear material. Furthermore, time-correlated neutron measurement systems that rely on thermalization and thermalized neutrons are not well suited for assaying advanced nuclear materials including materials with one or more neutron poisons (e.g., neutron absorbing materials, such as gadolinium (Gd) and boron (B)).

Other time-correlated neutron measurement systems perform neutron multiplicity measurements using unmoderated organic scintillators surrounding sides of an assembly containing nuclear material. The organic scintillators typically employ an organic material (e.g., an organic liquid, an organic solid, etc.) as a neutron detection medium, and, unlike ³He proportional counters, are generally not surrounded by a moderator material. The organic scintillators can detect and efficiently quantify fast neutrons (e.g., neutrons having a neutron energy level greater than or equal to 1.0 megaelectronvolt (MeV), also referred to as “fission spectrum” neutrons) produced by the nuclear material. Thus, unlike measurement systems relying on moderated ³He proportional counters, measurement systems employing organic scintillators preserve the energy and timing information of the neutrons produced by the nuclear material. In addition, organic scintillators exhibit nanosecond (ns) response times on the same time scale as that of the fission events (e.g., allowing for resolution of uncertainties in multiplication and detection efficiency). Furthermore, time-correlated neutron measurement systems that rely on fast neutron measurements have significantly shorter neutron die-away times associated therewith, and are better suited for assaying advanced nuclear materials including materials with neutron poisons. However, organic scintillator detectors are generally very temperature sensitive, fragile, flammable, sensitive to both neutrons and photons (e.g., increasing the risk of a photon being misclassified as a neutron), and require relatively complex data acquisition systems (e.g., complex systems having high-speed digitization electronics) and processes.

It would, therefore, be desirable to have new systems and methods for assaying nuclear materials that are fast, efficient, less complicated, more precise, and/or more versatile as compared to conventional systems and methods. It would also be desirable if such systems and methods were compatible with nuclear fuel assemblies including different types, concentrations, and/or arrangements of one or more of nuclear materials and neutron absorbing materials (e.g., neutron poisons).

### BRIEF SUMMARY

Embodiments described herein include systems and methods for assaying nuclear fuel. In accordance with one embodiment described herein, a nuclear fuel assay system comprises a nuclear fuel assembly comprising structures containing nuclear fuel, and a neutron collar surrounding sides of the nuclear fuel assembly and comprising pressurized ⁴He scintillation detectors.

In additional embodiments, a system for assaying nuclear fuel comprises a nuclear fuel assembly comprising nuclear-fuel-loaded structures, and a neutron collar laterally surrounding sides of the nuclear fuel assembly and comprising pressurized ⁴He scintillation detectors configured and positioned to receive fast neutrons from the nuclear fuel assembly. Each of the nuclear-fuel-loaded structures independently comprises a cladding structure, and a nuclear fuel material within the cladding structure and comprising one or more of uranium and plutonium. Each of the pressurized ⁴He scintillation detectors independently comprises a housing structure filled with ⁴He gas having a pressure greater than or equal to about 150 bar, and at least one sensor configured and positioned to detect radiation resulting from elastic scattering of the fast neutrons within the ⁴He gas.

In further embodiments, a method of quantifying nuclear material comprises surrounding an assembly comprising structures loaded with nuclear fuel with a neutron collar comprising an array of pressurized ⁴He scintillation detectors. Fast neutrons emitted from the assembly are detected using the array of pressurized ⁴He scintillation detectors. A mass of the nuclear fuel is determined at least partially based on the quantity of fast neutrons detected by the array of pressurized ⁴He scintillation detectors over a predetermined period of time.

### BRIEF DESCRIPTION OF THE DRAWINGS

FIG. 1 is a simplified top-down view of a nuclear fuel assay system, in accordance with an embodiment of the disclosure.

FIG. 2 is a simplified, partially transparent longitudinal view of a helium-4 detector of the nuclear fuel assay system shown in FIG. 1, in accordance with an embodiment of the disclosure.

FIGS. 3 through 17 are simplified top-down views of different nuclear fuel assay systems, in accordance with additional embodiments of the disclosure.

FIGS. 18 through 21 are graphs showing the results described in Examples 1 through 4, respectively.

### DETAILED DESCRIPTION

Systems and methods for assaying nuclear fuel (e.g., fresh nuclear fuel, partially spent nuclear fuel) are described. In some embodiments, a nuclear fuel assay system includes a nuclear fuel assembly including structures loaded with (e.g., containing) a nuclear fuel material (e.g., fresh nuclear fuel material comprising one or more isotopes of uranium and/or plutonium, partially spent nuclear fuel comprising one or more isotopes of uranium and/or plutonium), and a neutron collar surrounding sides of the nuclear fuel assembly and including a plurality of pressurized ⁴He scintillation detectors. The pressurized ⁴He scintillation detectors may be configured and operated to detect fast neutrons (e.g., fission-spectrum neutrons) emitted by the nuclear fuel assembly without previously lowering energies of the fast neutrons (e.g., without previously converting the fast neutrons to one or more of thermal neutrons and epithermal neutrons) using a moderator structure. In some embodiments, the neutron collar also includes at least one neutron source configured and operated to generate neutrons to interact with and effectuate a desired rate of induced fission with the nuclear fuel material of the nuclear fuel assembly. In additional embodiments, such as embodiments wherein the nuclear fuel material exhibits a relatively high rate of spontaneous fission, the at least one neutron source may be omitted (e.g., absent) from the neutron collar. Optionally, the neutron collar may further include one or more additional structures (e.g., moderator structures, filter structures, reflective structures, etc.) configured and positioned to assist in (e.g., enhance, refine, etc.) the detection of fast neutrons from the nuclear fuel assembly by the pressurized ⁴He scintillation detectors. The systems and methods of the disclosure may be faster, less complicated, more durable (e.g., less fragile), more versatile (e.g., less temperature sensitive), more scalable, more precise (e.g., may exhibit enhanced discrimination between photon-based signals and neutron-based signals), and/or more efficient as compared to conventional systems and conventional methods for assaying nuclear fuel.

In the following detailed description, reference is made to the accompanying drawings that form a part hereof and, in which is shown by way of illustration, specific embodiments in which the disclosure may be practiced. These embodiments are described in sufficient detail to enable those of ordinary skill in the art to practice that described in this disclosure, and it is to be understood that other embodiments may be utilized, and that structural, logical, and electrical changes may be made within the scope of the disclosure.

Referring in general to the following description and accompanying drawings, various embodiments of the disclosure are illustrated to show its structure and method of operation. Common elements of the illustrated embodiments are designated with like reference numerals. It should be understood that the figures presented are not meant to be illustrative of actual views of any particular portion of the actual structure, system, or method, but are merely idealized representations employed to more clearly and fully depict the disclosure defined by the appended claims.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof. As used herein, the term “may” with respect to a material, structure, feature or method act indicates that such is contemplated for use in implementation of embodiments of the disclosure and such term is used in preference to the more restrictive term “is” so as to avoid any implication that other, compatible materials, structures, features and methods usable in combination therewith should, or must be, excluded.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, “and/or” includes any and all combinations of one or more of the associated listed items.

As used herein, the term “configured” refers to a size, shape, material composition, and arrangement of one or more of at least one structure and at least one apparatus facilitating operation of one or more of the structure and the apparatus in a predetermined way.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

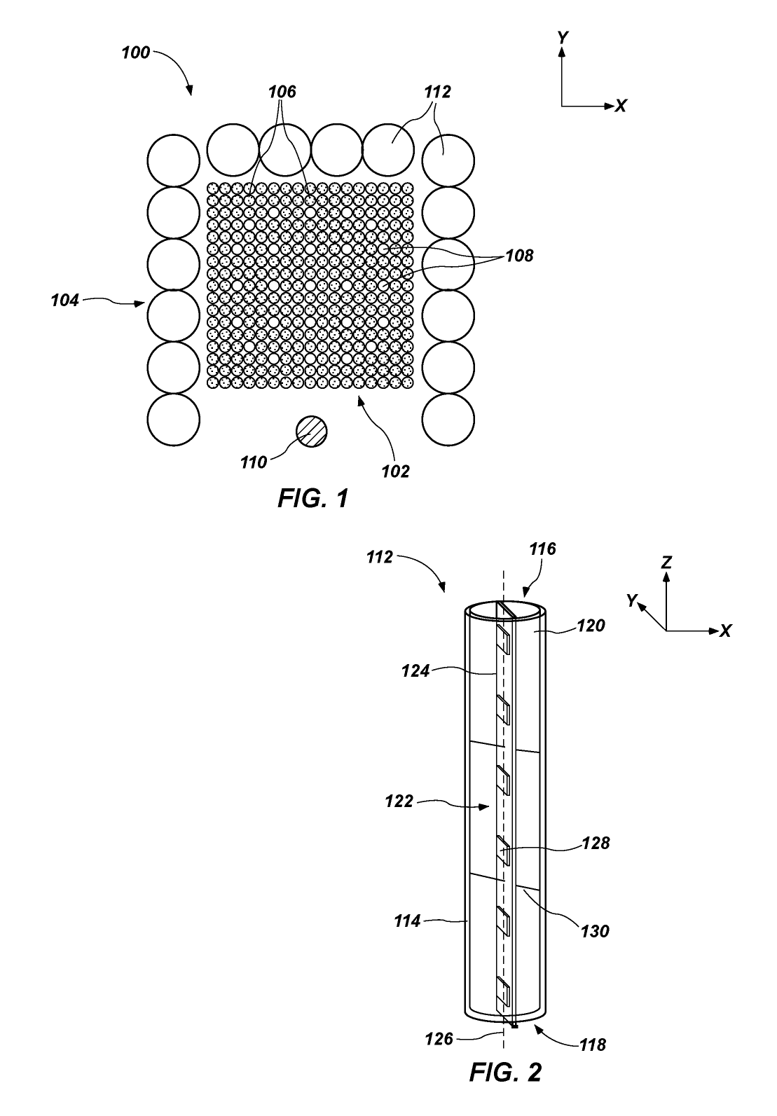

FIG. 1 is a simplified top-down view of a nuclear fuel assay system 100, in accordance with an embodiment of the disclosure. The nuclear fuel assay system 100 may be configured and operated to assay fresh (e.g., completely unirradiated) nuclear fuel, and determine a mass of the fresh nuclear fuel. The nuclear fuel assay system 100 may also be configured and operated to assay nuclear fuel in an intermediate (e.g., partially used, partially spent) state between a fresh (e.g., completely unirradiated) state and a spent (e.g., completely used, completely irradiated, end-of-life) state, and to determine a mass of the nuclear fuel in the intermediate state. The intermediate state of the nuclear fuel may occur after an initial (e.g., first) irradiation of the nuclear fuel but prior to a final (e.g., last) irradiation of the nuclear fuel. Fresh nuclear fuel and partially spent nuclear fuel are distinguishable in terms of material composition (e.g., radioisotope types and amounts) and radioactivity from spent nuclear fuel (e.g., completely used nuclear fuel, completely irradiated nuclear fuel). Unlike fresh nuclear fuel and partially spent nuclear fuel, spent nuclear fuel may, for example, no longer be able to sustain nuclear reactions (e.g., fission reactions) therein. As shown in FIG. 1, the nuclear fuel assay system 100 includes a nuclear fuel assembly 102, and a neutron collar 104 surrounding sides of the nuclear fuel assembly 102. With the description as provided below, it will be readily apparent to one of ordinary skill in the art that the nuclear fuel assay system 100 described herein may be used in various applications. In other words, the nuclear fuel assay system 100 may be used whenever it is desired to directly measure (e.g., count) fast neutrons produced by a nuclear material, and/or to count correlated fast neutrons.

It is noted that in FIG. 1, various components of the nuclear fuel assay system 100 (e.g., components of the nuclear fuel assembly 102, components of the neutron collar 104, etc.) are shown as being provided at particular locations relative to one another. However, the various components of the nuclear fuel assay system 100 are shown in FIG. 1 at such particular locations for simplicity and not as a physical limitation. As described in further detail below, one or more of the various components of the nuclear fuel assay system 100 may be provided at different locations relative to one another than those depicted in FIG. 1.

The nuclear fuel assembly 102 includes an array of nuclear-fuel-loaded structures 106 (e.g., fuel rods, fuel pins, etc.) and empty structures 108 (e.g., empty rods, empty pins, coolant channels, instrumentation channels, etc.). The nuclear fuel assembly 102 may exhibit any desired quantities (e.g., amounts, numbers, etc.) and arrangements of the nuclear-fuel-loaded structures 106 and the empty structures 108, such as quantities and arrangements associated with conventional nuclear fuel assembly configurations (e.g., conventional light water reactor (LWR) nuclear fuel assembly configurations, such as conventional boiling water reactor (BWR) nuclear fuel assembly configurations, conventional pressurized water reactor (PWR) nuclear fuel assembly configurations, etc.). For example, as shown in FIG. 1, the nuclear fuel assembly 102 may exhibit a conventional PWR nuclear fuel assembly configuration including a square, 17×17 array (e.g., an array including seventeen (17) rows and seventeen (17) columns) of the nuclear-fuel-loaded structures 106 and the empty structures 108. The array may include two hundred sixty-four (264) of the nuclear-fuel-loaded structures 106, and twenty-five (25) of the empty structures 108. In additional embodiments, the nuclear fuel assembly 102 may exhibit a different configuration, such a configuration including one or more of a different lateral peripheral shape (e.g., a non-square lateral peripheral shape, such as generally circular lateral peripheral shape, or a generally hexagonal shape), a different array size (e.g., an array including less than seventeen (17) rows and/or less than seventeen (17) columns of the nuclear-fuel-loaded structures 106 and the empty structures 108, such as a 14×14 array, a 15×15 array, or a 16×16 array; an array including greater than seventeen (17) rows and/or greater than seventeen (17) columns of the nuclear-fuel-loaded structures 106 and the empty structures 108; etc.), a different quantity of the nuclear-fuel-loaded structures 106 (e.g., less than two hundred sixty-four (264) of the nuclear-fuel-loaded structures 106, greater than two hundred sixty-four (264) of the nuclear-fuel-loaded structures 106), a different quantity of the empty structures 108, and a different arrangement of the nuclear-fuel-loaded structures 106 relative to the empty structures 108.

Each of the nuclear-fuel-loaded structures 106 may independently be formed of and include a cladding structure (e.g., a cladding tube) and one or more nuclear fuel structures (e.g., nuclear fuel pellets) loaded (e.g., stacked) within the cladding structure. The cladding structure may be formed of and include one or more conventional cladding materials, such as one or more of a zirconium-based alloy (e.g., Zircaloy-2, Zircaloy-4, ZrSn, ZIRLO®), an iron-based alloy (e.g., an FeCrAl steel), and a ceramic material (e.g., silicon carbide). The nuclear fuel structures may be formed of and include a nuclear fuel material (e.g., a fresh nuclear fuel material, a partially spent nuclear fuel material), such as one or more of a uranium-containing material (e.g., pure uranium metal (UM), a uranium alloy, uranium dioxide (UO₂), etc.), a plutonium-containing material (e.g., pure plutonium metal (PM), a plutonium alloy, plutonium dioxide (PuO₂), etc.), and a mixed oxide (MOX) material (e.g., an oxide material including a blend of plutonium and uranium), The nuclear fuel structures may include any desired type(s) and any desired amount(s) of one or more isotopes of uranium and/or plutonium. In some embodiments, the nuclear fuel structures are formed of and include a nuclear fuel material requiring interrogating radiation to induce sufficient fission therein to determine a mass thereof (e.g., as opposed to a nuclear fuel material exhibiting a sufficiently high rate of spontaneous fission to determine a mass thereof without the use of interrogating radiation). For example, the nuclear fuel structures may be formed of and include one or more of uranium-235 (²³⁵U), uranium-238 (²³⁸U), and plutonium-239 (²³⁹Pu). Optionally, the nuclear fuel structures of one or more of the nuclear-fuel-loaded structures 106 may also include at least one burnable neutron poison (e.g., at least one material having a high neutron absorption cross section), such as one or more of Gd and B. By way of non-limiting example, the nuclear fuel structures of at least a portion of the nuclear-fuel-loaded structures 106 may include from about five (5) weight percent (wt %) Gd to about twelve (12) wt % Gd.

Each of the nuclear-fuel-loaded structures 106 may be substantially the same, or at least one of the nuclear-fuel-loaded structures 106 may be different than at least one other of the nuclear-fuel-loaded structures 106. In some embodiments, each of the nuclear-fuel-loaded structures 106 is substantially the same as each other of the nuclear-fuel-loaded structures 106. In additional embodiments, at least one of the nuclear-fuel-loaded structures 106 is different than at least one other of the nuclear-fuel-loaded structures 106. For example, at least one or the nuclear-fuel-loaded structures 106 may exhibit one or more of a different cladding structure and different nuclear fuel structure(s) within the cladding structure than at least one other of the nuclear-fuel-loaded structures 106. In some embodiments, at least one of the nuclear-fuel-loaded structures 106 includes a different material composition of the nuclear fuel structure(s) thereof than at least one other of the nuclear-fuel-loaded structures 106. At least one of the nuclear-fuel-loaded structures 106 may, for example, include different types and/or different amounts of one or more radioactive isotopes and/or of one or more burnable neutron poisons than at least one other of the nuclear-fuel-loaded structures 106. The nuclear fuel assembly 102 may exhibit any desired distribution of different nuclear-fuel-loaded structures 106.

With continued reference to FIG. 1, the neutron collar 104 may exhibit an active configuration including at least one neutron source 110 positioned adjacent (e.g., next to, neighboring, etc.) a side of the nuclear fuel assembly 102, and a plurality of pressurized helium-4 (⁴He) scintillation detectors 112 positioned adjacent additional sides of the nuclear fuel assembly 102. For example, as shown in FIG. 1, the neutron source 110 may be positioned proximate one (1) of four (4) different lateral sides of the nuclear fuel assembly 102, and the pressurized ⁴He scintillation detectors 112 may each independently be positioned proximate at least one other of the four (4) different lateral sides of the nuclear fuel assembly 102. In additional embodiments, such as embodiments wherein the nuclear fuel assembly 102 exhibits a different number of sides (e.g., less than four (4) sides, greater than four (4) sides, etc.), the nuclear fuel assembly 102 may exhibit different arrangements of the neutron source 110 and the pressurized ⁴He scintillation detectors 112.

The neutron source 110 may comprise any apparatus or structure able to generate neutrons to actively interrogate the nuclear fuel assembly 102. The generated neutrons from the neutron source 110 may induce fission in the nuclear fuel material of the nuclear fuel assembly 102 to produce fast neutrons that may be detected by the ⁴He scintillation detectors 112 to determine a mass of the nuclear fuel material. By way of non-limiting example, the neutron source 110 may comprise a source configured and operated to use radioisotopes (e.g., californium-252 (²⁵²Cf), americium-241, (²⁴¹Am), antimony-124 (¹²⁴Sb), etc.) to produce neutrons, an accelerator-based neutron source (e.g., an open-vacuum, accelerator-based neutron source; a sealed-vacuum, accelerator-based neutron source; etc.) configured and operated to fuse light nuclei with a particle accelerator, an X-ray-based neutron source, or a photon-based neutron source. In some embodiments, the neutron source 110 comprises a radioisotope neutron source. The radioisotope neutron source may produce neutrons direct through spontaneous fission (e.g., using, for example, ²⁵²Cf), or may produce neutrons indirectly through alpha-emitting radionuclides (e.g., ²⁴¹Am) or high-energy gamma ray emitting radionuclides (e.g., ¹²⁴Sb). In some embodiments, the neutron source 110 comprises an americium-lithium (AmLi) source.

The neutron source 110 may be laterally offset (e.g., laterally spaced apart, etc.) from the nuclear fuel assembly 102 by any distance permitting neutrons emitted from the neutron source 110 to effectuate a desired rate of induced fission within the nuclear fuel material of the nuclear-fuel-loaded structures 106 of the nuclear fuel assembly 102. By way of non-limiting example, the neutron source 110 may be laterally offset from the nuclear fuel assembly 102 by a distance greater than or equal to about 50 millimeters (mm), such as a distance within a range of from about 50 mm to about 100 mm. The neutron source 110 may also be laterally offset from the pressurized ⁴He scintillation detectors 112 most proximate thereto by a distance sufficient to mitigate (or even circumvent) undesired detection of neutrons emitted from the neutron source 110 by the pressurized ⁴He scintillation detectors 112. By way of non-limiting example, the neutron source 110 may be laterally offset from the pressurized ⁴He scintillation detectors 112 most proximate thereto by a distance greater than or equal to about 50 mm, such as a distance within a range of from about 50 mm to about 100 mm. The detection of neutrons emitted from sources (e.g., the neutron source 110) other than the nuclear fuel assembly 102 is referred to herein as “neutron accidentals.” Accordingly, the position of the neutron source 110 relative to the positions of the pressurized ⁴He scintillation detectors 112 may be selected to reduce the occurrence of neutron accidentals during use and operation of the nuclear fuel assay system 100.

The pressurized ⁴He scintillation detectors 112 may comprise scintillation detectors employing pressurized ⁴He gas as a sensing medium to detect fast neutrons produced by the nuclear fuel assembly 102. Non-limiting examples of scintillation detectors suitable for use as the pressurized ⁴He scintillation detectors 112 are described in U.S. Pat. Pub. No. 2014/0375606, filed Jun. 24, 2103, to Gendotti et al., the entire disclosure of which is incorporated in its entirety herein by reference.

By way of non-limiting example, in accordance with an embodiment of the disclosure, FIG. 2 shows a simplified, partially transparent longitudinal view of one of the pressurized ⁴He scintillation detectors 112 of the nuclear fuel assay system 102 depicted in FIG. 1. As shown in FIG. 2, the pressurized ⁴He scintillation detector 112 may include a housing structure 114 (e.g., a tubular metallic housing structure, such as a tubular stainless steel housing structure) having a first end 116, an opposing, second end 118, and an interior surface 120 at least partially defining an interior chamber 122 filled with pressurized ⁴He gas. In some embodiments, the housing structure 114 has an external diameter of about 52 millimeters (mm), and the interior chamber 122 has a length of about 600 mm. The interior surface 120 of the housing structure 114 may be coated (e.g., lined, covered, etc.) with a wavelength-shifting (WLS) material formulated to convert vacuum ultraviolet (VUV) spectrum scintillation radiation (e.g., 70 nm scintillation radiation) produced through elastic scattering of fast neutrons in the pressurized ⁴He gas to visible spectrum radiation. In addition, control circuitry may be operatively associated with the first end 116 of the housing structure 114, and an ⁴He gas flow control device (e.g., a valve) may be operatively associated with the opposing, second end 118 of the housing structure 114, or vice versa. The pressurized ⁴He scintillation detector 112 also includes a circuit board 124 positioned about a central longitudinal axis 126 of the housing structure 114. The circuit board 124 may include light sensors 128 (e.g., semiconductive light sensors, such as silicon photomultipliers (SiPMs)) configured and operated to detect the visible spectrum radiation generated by the WLS material. Optionally, the ⁴He scintillation detector 112 may further include one or more dividing structures 130 (e.g., baffle structures) extending between the housing structure 114 and the circuit board 124 and dividing two or more sections (e.g., regions) of the interior chamber 122. In some embodiments, the ⁴He scintillation detector 112 includes at least two (2) dividing structures 130 partitioning the interior chamber 122 into at least three (3) sections (e.g., three segments each about 200 mm in length).

The pressurized ⁴He scintillation detectors 112 may be operated under any conditions (e.g., ⁴He gas pressures, temperatures, etc.) facilitating the detection of fast neutrons produced by the nuclear fuel assembly 102. For example, due to the low density of ⁴He gas at atmospheric pressure, the ⁴He gas of each of the pressurized ⁴He scintillation detectors 112 may be pressurized to a level sufficient to facilitate a desirable average fast neutron detection efficiency, such as an average fast neutron detection efficiency greater than or equal to about 6 percent (e.g., greater than or equal to about 7 percent, greater than or equal to about 8 percent, greater than or equal to about 9 percent, greater than or equal to about 10 percent, greater than or equal to about 11 percent, or greater than or equal to about 12 percent) within a fast neutron energy range of from about 1.0 MeV to about 6.0 MeV. Each of the pressurized ⁴He scintillation detectors 112 may, for example, be operated at an ⁴He gas pressure greater than or equal to about 150 bar, such as a ⁴He gas pressure within a range of from about 150 bar to about 200 bar, within a range of from about 175 bar to about 200 bar, or about 200 bar. In some embodiments, the ⁴He gas of each of the pressurized ⁴He scintillation detectors is pressurized to about 200 bar. Operating the pressurized ⁴He scintillation detectors at ⁴He gas pressures greater than or equal to about 150 bar may also permit neutron-based scintillation events (e.g., neutron signals) to be readily distinguished from photon-based scintillation events (e.g., gamma-ray signals) through energy and pulse shape discrimination (PSD) methodologies.

In additional embodiments, one or more of the pressurized ⁴He scintillation detectors 112 may exhibit a different configuration than that depicted in FIG. 2. One or more of the pressurized ⁴He scintillation detectors 112 may, for example, exhibit a configuration wherein the circuit board 124 (including the light sensors 128 thereof) is not positioned about the central longitudinal axis 126 of the housing structure 114. By way of non-limiting example, the pressurized ⁴He scintillation detector 112 may still include pressurized ⁴He gas as a scintillation medium within the interior chamber 122 of the housing structure 114, but in place of the circuit board 124 (including the light sensors 128 thereof) within the interior chamber 122, the pressurized ⁴He scintillation detector 112 may include a photomultiplier tube (PMT) positioned at one or more of the first end 116, and the opposing, second end 118 of the housing structure 114.

With returned reference to FIG. 1, the pressurized ⁴He scintillation detectors 112 may be oriented in parallel to the nuclear fuel assembly 102. In addition, as shown in FIG. 1, sides of the nuclear fuel assembly 102 having the pressurized ⁴He scintillation detectors 112 laterally adjacent thereto may each exhibit a single (e.g., only one) line (e.g., a single line extending in the X-direction, the Y-direction, or a combination thereof) of the pressurized ⁴He scintillation detectors 112 laterally adjacent thereto. The pressurized ⁴He scintillation detectors 112 within a given line (e.g., a given row, a given column, etc.) may be substantially aligned with each other of the pressurized ⁴He scintillation detectors 112 within the given line, or at least one of the pressurized ⁴He scintillation detectors 112 within the given line may be unaligned with at least one other of the pressurized ⁴He scintillation detectors 112 within the given line. In some embodiments, pressurized ⁴He scintillation detectors 112 within a given line are substantially aligned with each other of the pressurized ⁴He scintillation detectors 112 within the given line.

Each of pressurized ⁴He scintillation detectors 112 may independently be laterally offset (e.g., laterally spaced apart) from the nuclear fuel assembly 102 and the other pressurized ⁴He scintillation detectors 112 laterally adjacent thereto by any distance(s) facilitating the efficient detection of fast neutrons emitted from the nuclear fuel assembly 102. By way of non-limiting example, each of the pressurized ⁴He scintillation detectors 112 may independently be laterally offset from the nuclear fuel assembly 102 and the other pressurized ⁴He scintillation detectors 112 laterally adjacent thereto by one or more distance(s) permitting the neutron collar 104 to have an average fast neutron detection efficiency of greater than or equal to about 6 percent (e.g., greater than or equal to about 7 percent, greater than or equal to about 8 percent, greater than or equal to about 9 percent, greater than or equal to about 10 percent, greater than or equal to about 11 percent, or greater than or equal to about 12 percent). In some embodiments, each of the pressurized ⁴He scintillation detectors 112 is independently laterally offset from at least one side of the nuclear fuel assembly 102 by a distance within a range of from about 100 mm to about 250 mm, and is also independently laterally offset from other pressurized ⁴He scintillation detectors 112 laterally adjacent thereto by a distance within a range of from about 0 mm to about 100 mm.

The neutron collar 104 may include any desired quantity (e.g., amount, number, etc.) of the pressurized ⁴He scintillation detectors 112. The quantity of pressurized ⁴He scintillation detectors 112 included in the neutron collar 104 may at least partially depend on the configuration (e.g., size, shape, material composition, components, component arrangement, etc.) of the nuclear fuel assembly 102. As shown in FIG. 1, in some embodiments, the neutron collar 104 includes sixteen (16) of the pressurized ⁴He scintillation detectors 112 surrounding sides of the nuclear fuel assembly 102. In additional embodiments, the neutron collar 104 may include a different quantity of the pressurized ⁴He scintillation detectors 112, such as greater than sixteen (16) (e.g., greater than or equal to twenty (20), greater than or equal to thirty (30), greater than or equal to forty (40), etc.) of the of the pressurized ⁴He scintillation detectors 112, or less than sixteen (16) (e.g., less than or equal to fourteen (14), less than or equal to twelve (12), less than or equal to ten (10), less than or equal to eight (8), etc.) of the pressurized ⁴He scintillation detectors 112. Each of the pressurized ⁴He scintillation detectors 112 included in the neutron collar 104 may exhibit substantially the same configuration as each other of the pressurized ⁴He scintillation detectors 112, or at least one of the pressurized ⁴He scintillation detectors 112 may exhibit a different configuration than at least one other of the pressurized ⁴He scintillation detectors 112.

The neutron collar 104 may be positioned relative to the nuclear fuel assembly 102 by any desired means. As a non-limiting example, the neutron collar 104 may be provided in a vertical (e.g., longitudinally-extending) orientation, and then the nuclear fuel assembly 102 may be delivered (e.g., by way of a crane) into a central opening (e.g., cavity) defined by the neutron collar 104. As another non-limiting example, the neutron collar 104 may be provided in a horizontal (e.g., laterally-extending) orientation, and then the nuclear fuel assembly 102 may be delivered (e.g., slid) into the central opening defined by the neutron collar 104. In some embodiments, one or more sides of the neutron collar 104 are configured to be positionally adjusted (e.g., moved, such as hingably moved, slidably moved, etc.; removed; etc.) to assist with or facilitate positioning the nuclear fuel assembly 102 within the central opening defined by the neutron collar 104. For example, at least one side of the neutron collar 104 may be temporarily moved (e.g., temporarily removed), the nuclear fuel assembly 102 may be delivered into the central opening defined by the neutron collar 104 through an opening (e.g., entrance) formed by the movement of the side, and then the side of the neutron collar 104 may be the returned to its original positioned. The neutron collar 104 may be stationary (e.g., non-mobile) and the nuclear fuel assembly 102 may be mobile (e.g., non-stationary) during the delivery of the nuclear fuel assembly 102 into the central opening defined by the neutron collar 104, the neutron collar 104 may be mobile and the nuclear fuel assembly 102 may be stationary during the delivery of the nuclear fuel assembly 102 into the central opening defined by the neutron collar 104, or both the neutron collar 104 and the nuclear fuel assembly 102 may be mobile during the delivery of the nuclear fuel assembly 102 into the central opening defined by the neutron collar 104. In some embodiments, the neutron collar 104 is provided (e.g., mounted, such as removably mounted) on a mobile device (e.g., a cart) to assist with or facilitate positioning the neutron collar 104 relative to the nuclear fuel assembly 102. The components (e.g., nuclear-fuel-loaded structures 106, empty structures 108, etc.) of the nuclear fuel assembly 102 may be delivered into the central opening defined by the neutron collar 104 simultaneously (e.g., with one another), sequentially (e.g., separate from one another), or a combination thereof.

Referring collectively to FIGS. 1 and 2, during use and operation of the nuclear fuel assay system 100, neutrons emitted from the neutron source 110 may be received by and interact with the nuclear fuel material of the nuclear-fuel-loaded structures 106 of the nuclear fuel assembly 102 to induce fission and produce fast neutrons. The fast neutrons may be received by the pressurized ⁴He scintillation detectors 112, wherein elastic scattering of the fast neutrons within the pressurized ⁴He gas contained in the interior chamber 122 of the housing structure 114 may generate VUV wavelength scintillation photons. The generated VUV wavelength scintillation light may then interact with the WLS material covering the inner surface of the housing structure 114 to generate visible wavelength photons. At least a portion of the generated visible wavelength photons may then interact with and be detected by the light sensors 128 of the circuit board 124. The circuit board 124 may then send transistor-transistor logic (TTL) output to a computer/electronics assembly to evaluate the mass of nuclear fuel material within the nuclear fuel assembly 102 through one or more computer-numerically-assisted processes employing conventional data analysis methodologies for nuclear material mass quantification. In some embodiments, the computer-numerically-assisted processes automatically discriminate between fast-neutron-based signals and photon-based signals (e.g., gamma-ray signals) through evaluation of one or more of the photoelectron signal amplitudes and scintillation light decay time. In additional embodiments, the computer-numerically-assisted processes automatically adjust for crosstalk resulting from neutron scattering between the pressurized ⁴He scintillation detectors 112. The computer-numerically-assisted processes may, for example, disregard (e.g., reject) signals received from a neighboring pressurized ⁴He scintillation detector 112 within a predetermined time period, and/or may disregard signals associated with neutrons having energies below predetermined threshold energy levels (e.g., neutron energies less than or equal to about 750 kiloelectronvolts (keV), such as less than or equal to about 600 keV, or less than or equal to about 500 keV).

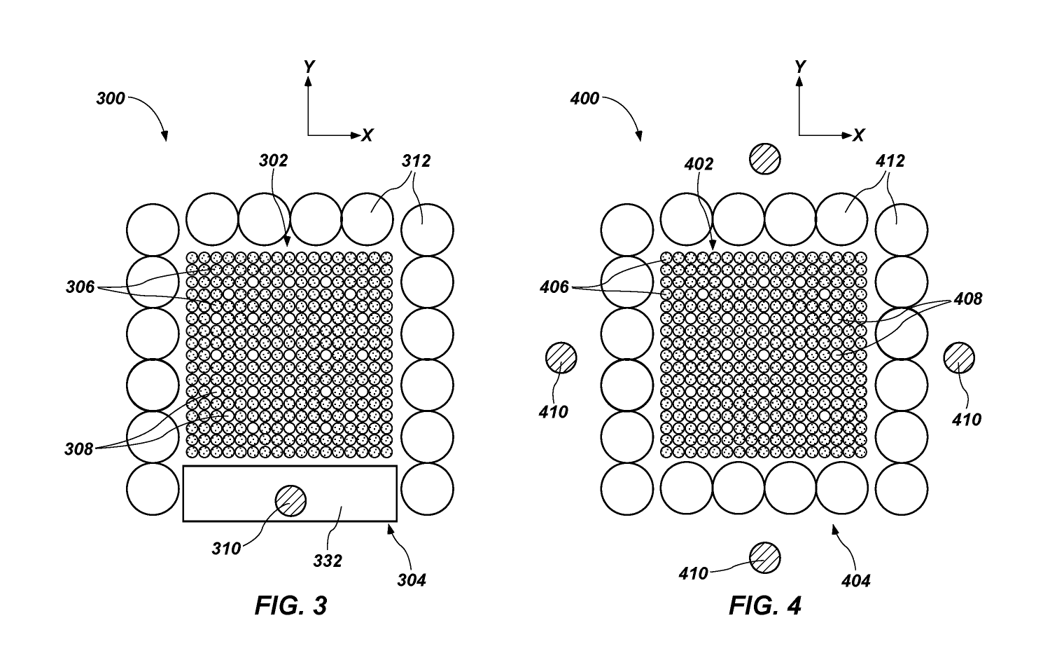

As previously described above, the nuclear fuel assay system 100 may be formed to exhibit a different configuration than that depicted in FIG. 1. By way of non-limiting example, FIGS. 3 through 17 show top-down views of different nuclear fuel assay systems, in accordance with additional embodiments of the disclosure. Throughout the remaining description and the accompanying figures, functionally similar features (e.g., structures, apparatuses, etc.) are referred to with similar reference numerals incremented by 100. To avoid repetition, not all features shown in FIGS. 3 through 17 are described in detail herein. Rather, unless described otherwise below, a feature designated by a reference numeral that is a 100 increment of the reference numeral of a previously-described feature (whether the previously-described feature is first described before the present paragraph, or is first described after the present paragraph) will be understood to be substantially similar to the previously-described feature.

FIG. 3 illustrates a top-down view of a nuclear fuel assay system 300, in accordance with another embodiment of the disclosure. As shown in FIG. 3, the nuclear fuel assay system 300 is similar to the nuclear fuel assay system 100 shown in FIG. 1, except that the neutron collar 304 further includes a moderator structure 332 at least partially (e.g., completely) surrounding the neutron source 310. The moderator structure 332 may be formed of and include a moderator material formulated to scatter neutrons emitted by the neutron source 310. By way of non-limiting example, the moderator structure 332 may be formed of and include high-density polyethylene (HDPE) (e.g., polyethylene having a density within a range of from about 0.93 g/cm³ to about 0.97 g/cm³). Scattering neutrons emitted by the neutron source 310 may lower the energy of the neutrons to levels (e.g., thermal and/or epithermal neutron energy levels) desirable for inducing fission in the nuclear fuel material of the nuclear-fuel-loaded structures 306 of the nuclear fuel assembly 302, and may also direct neutrons that may otherwise (i.e., in the absence of the moderator structure 332) travel away from the nuclear fuel assembly 302 into the nuclear fuel assembly 302 to facilitate an increased number of induced fission events (and, hence, an increased number of produced neutrons) in the nuclear fuel material. The moderator structure 332 may also lower the energies of the neutrons emitted by the neutron source 332 to levels (e.g., thermal and/or epithermal neutron energy levels) below the sensitivity of the pressurized ⁴He scintillation detectors 312 to reduce the occurrence of neutron accidentals during use and operation of the nuclear fuel assay system 300. The nuclear fuel assay system 300 may be used to determine a mass of the nuclear fuel material within the nuclear fuel assembly 302 thereof in a manner substantially similar to that previously described with respect to the nuclear fuel assay system 100 shown in FIG. 1.

FIG. 4 illustrates a top-down view of a nuclear fuel assay system 400, in accordance with another embodiment of the disclosure. As shown in FIG. 4, the pressurized ⁴He scintillation detectors 412 of the neutron collar 404 may surround each side of the nuclear fuel assembly 402. For example, each side of the nuclear fuel assembly 402 may exhibit a line (e.g., row, column, etc.) of the ⁴He scintillation detectors 412 laterally adjacent thereto. In addition, neutron generators 410 may be positioned outwardly (e.g., relative to the nuclear fuel assembly 402) laterally adjacent the pressurized ⁴He scintillation detectors 412. For example, as shown in FIG. 4, each side of the nuclear fuel assembly 402 may exhibit at least one neutron generator 410 positioned laterally proximate thereto, and the pressurized ⁴He scintillation detectors 412 may laterally intervene between the neutron generators 410 and the nuclear fuel assembly 402. The neutron collar 404 may include any desired quantities of the pressurized ⁴He scintillation detectors 412 and the neutron generators 410. For example, as shown in FIG. 4, the neutron collar 404 may include twenty (20) pressurized ⁴He scintillation detectors 412 and four (4) neutron generators 410 (e.g., corresponding to the four (4) sides of the nuclear fuel assembly 402). In additional embodiments, the neutron collar 404 may include a different quantity (e.g., less than twenty (20), or greater than twenty (20)) of the pressurized ⁴He scintillation detectors 412, and/or a different quantity (e.g., less than four (4), or greater than four (4)) of the neutron generators 410. The increased quantity of neutron generators 410 in the neutron collar 404 (e.g., relative to the neutron collar 104 shown in FIG. 1) may increase the quantity of neutrons directed into the nuclear fuel material of the nuclear-fuel-loaded structures 406 of the nuclear fuel assembly 402, so as to increase the amount of induced fission in the nuclear fuel material (and, hence, the quantity of neutrons produced by the nuclear fuel material). In addition, the positioning of the neutron generators 410 may increase the uniformity of neutron penetration into the nuclear fuel assembly 402. Furthermore, the quantity and positioning of the pressurized ⁴He scintillation detectors 412 may increase the quantity of fast neutrons from the nuclear fuel material intercepted and detected by the pressurized ⁴He scintillation detectors 412. The nuclear fuel assay system 400 may be used to determine a mass of the nuclear fuel material within the nuclear fuel assembly 402 thereof in a manner substantially similar to that previously described with respect to the nuclear fuel assay system 100 shown in FIG. 1.

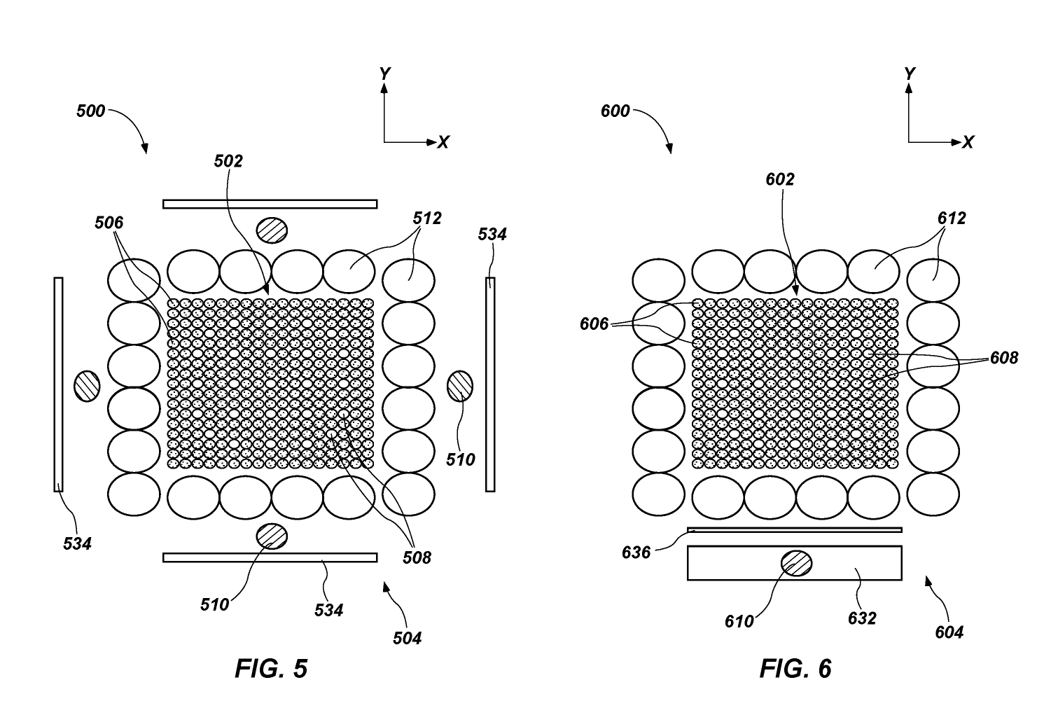

FIG. 5 illustrates a top-down view of a nuclear fuel assay system 500, in accordance with another embodiment of the disclosure. As shown in FIG. 5, the nuclear fuel assay system 500 is similar to the nuclear fuel assay system 400 shown in FIG. 4, except that the neutron collar 504 further includes one or more reflective structures 534 positioned outwardly (e.g., relative to the nuclear fuel assembly 502) laterally adjacent the neutron sources 510. The reflective structures 534 may be formed of and include a material formulated to scatter neutrons emitted by the neutron sources 510. By way of non-limiting example, the reflective structures 534 may be formed of and include HDPE. Scattering neutrons emitted by the neutron source 510 with the reflective structures 534 may direct neutrons that may otherwise (i.e., in the absence of the reflective structures 534) travel away from the nuclear fuel assembly 502 into the nuclear fuel assembly 502 to facilitate an increased number of induced fission events (and, hence, an increased number of produced neutrons) in the nuclear fuel material of the nuclear-fuel-loaded structures 506. As shown in FIG. 5, the neutron collar 504 may include a plurality of reflective structures 534, wherein each of the reflective structures 534 is discrete from each other of the reflective structures 534 and is positioned laterally outwardly adjacent a different neutron source 510. In additional embodiments, one or more of the reflective structures 534 may exhibit a different structural configuration (e.g., shape, size) than that depicted in FIG. 5. One or more of the reflective structures 534 may, for example, comprise a continuous structure including portions positioned laterally outwardly adjacent different neutron sources 510 positioned proximate different sides of the nuclear fuel assembly 502. By way of non-limiting example, the neutron collar 504 may include a single (e.g., only one), continuous reflective structure 534 that outwardly laterally surrounds each of the neutron sources 510. The nuclear fuel assay system 500 may be used to determine a mass of the nuclear fuel material within the nuclear fuel assembly 502 thereof in a manner substantially similar to that previously described with respect to the nuclear fuel assay system 100 shown in FIG. 1.

FIG. 6 illustrates a top-down view of a nuclear fuel assay system 600, in accordance with another embodiment of the disclosure. As shown in FIG. 6, the neutron collar 604 of the nuclear fuel assay system 600 includes pressurized ⁴He scintillation detectors 612 surrounding each side of a nuclear fuel assembly 602 thereof (e.g., similar to the configuration of the nuclear fuel assay system 400 previously described in relation to FIG. 4), and a moderator structure 632 at least partially (e.g., completely) surrounding a neutron source 610 (e.g., similar to the configuration of the nuclear fuel assay system 300 previously described in relation to FIG. 3) positioned proximate a side of the nuclear fuel assembly 602. In addition, the neutron collar 604 further includes a filter structure 636 laterally intervening between the pressurized ⁴He scintillation detectors 612 and each of the neutron source 610 and the moderator structure 632. The filter structure 636 may be formed of and include a material formulated to absorb neutrons (e.g., thermal neutrons, epithermal neutrons, etc.) having energies below a predetermined energy level. By way of non-limiting example, the filter structure 636 may be formed of and include one or more of a cadmium-containing material, a boron-containing material, a gadolinium-containing material, and another material with a high thermal and epithermal neutron cross-section. The filter structure 636 may prevent neutrons exiting the moderator structure 632 with insufficient energy to penetrate deeply into the nuclear fuel assembly 602 from being directed into the nuclear fuel assembly 602. Accordingly, the filter structure 636 may increase neutron penetration uniformity, especially in embodiments wherein the nuclear fuel material within a least a portion of the nuclear-fuel-loaded structures 608 includes one or more burnable neutron poisons (e.g., Gd, B, etc.). As shown in FIG. 6, in some embodiments, only one side of the nuclear fuel assembly 602 includes the neutron source 610, the moderator structure 632, and the filter structure 636 positioned laterally proximate thereto. In additional embodiments, more than one (e.g., each) side of the nuclear fuel assembly 602 includes at least one neutron source 610, at least one moderator structure 632, and at least one filter structure 636 positioned laterally proximate thereto. The nuclear fuel assay system 600 may be used to determine a mass of the nuclear fuel material within the nuclear fuel assembly 602 thereof in a manner substantially similar to that previously described with respect to the nuclear fuel assay system 100 shown in FIG. 1.

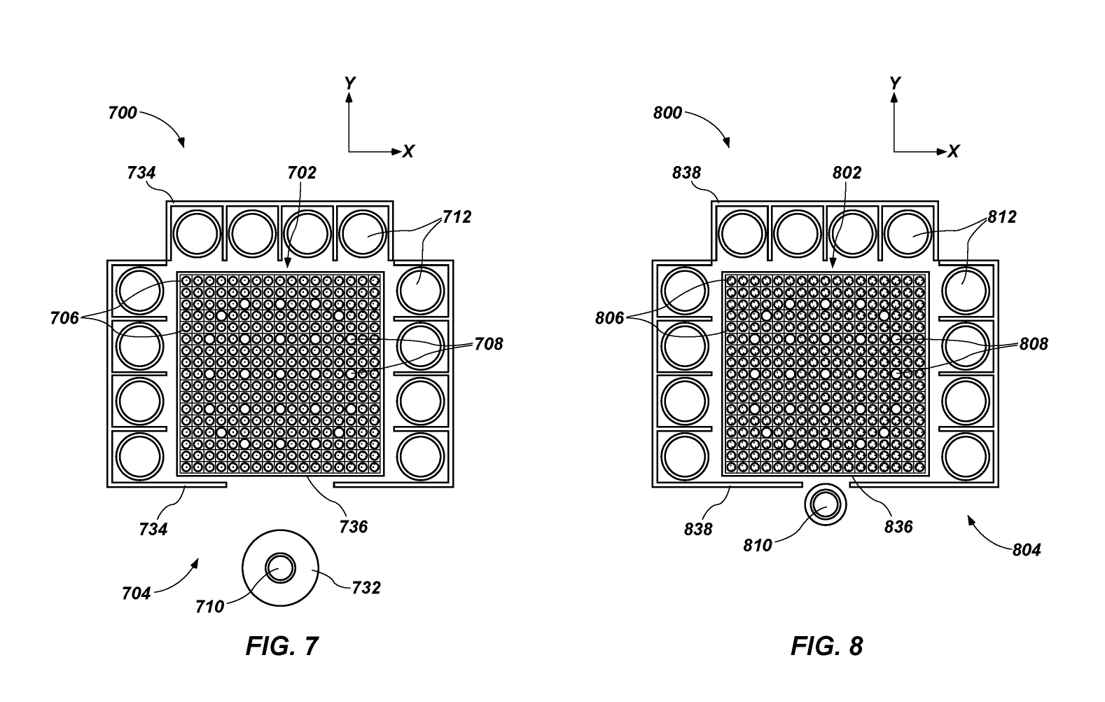

FIG. 7 illustrates a top-down view of a nuclear fuel assay system 700, in accordance with another embodiment of the disclosure. As shown in FIG. 7, the neutron collar 704 of the nuclear fuel assay system 700 includes pressurized ⁴He scintillation detectors 712 surrounding less than all of the sides of the nuclear fuel assembly 702, and a neutron source 710 proximate a side of the nuclear fuel assembly 702 not surrounded by the pressurized ⁴He scintillation detectors 712. The neutron collar 704 also includes at least one filter structure 736 surrounding one or more (e.g., each) of the sides of the nuclear fuel assembly 702, a moderator structure 732 at least partially (e.g., completely) surrounding the neutron source 710, and at least one reflective structure 734 surrounding sides of the pressurized ⁴He scintillation detectors 712. The filter structure 736 may laterally intervene between the nuclear fuel assembly 702 and each of the neutron source 710 and the ⁴He scintillation detectors 712. The moderator structure 732 may substantially surround at least one side of the neutron source 710 opposing the nuclear fuel assembly 702. The reflective structure 734, which may have a material composition substantially similar to that of the reflective structure 534 previously described in relation to FIG. 5, may be positioned outwardly laterally adjacent the pressurized ⁴He scintillation detectors 712, and may also laterally intervene between adjacent pressurized ⁴He scintillation detectors 712. The reflective structure 734 may reduce crosstalk that may otherwise result from neutron scattering between the pressurized ⁴He scintillation detectors 712, and may also facilitate an increased neutron detection efficiency by directing neutrons that travel past (e.g., bypass) a given pressurized ⁴He scintillation detector 712 without detection into the pressurized ⁴He scintillation detector 712 for detection. The nuclear fuel assay system 700 may be used to determine a mass of the nuclear fuel material within the nuclear fuel assembly 702 thereof in a manner substantially similar to that previously described with respect to the nuclear fuel assay system 100 shown in FIG. 1.

FIG. 8 illustrates a top-down view of a nuclear fuel assay system 800, in accordance with another embodiment of the disclosure. As shown in FIG. 8, the nuclear fuel assay system 800 is similar to the nuclear fuel assay system 700 shown in FIG. 7, except that the neutron source 810 is positioned more proximate (e.g., closer) to the nuclear fuel assembly 802, and is not surrounded by a moderator structure. The configuration of the nuclear fuel assay system 800 shown in FIG. 8 may, for example, permit higher energy neutrons emitted from the neutron source 810 to penetrate more deeply and uniformly into the nuclear fuel assembly 802, especially in embodiments wherein the nuclear fuel material within a least a portion of the nuclear-fuel-loaded structures 808 includes one or more burnable neutron poisons (e.g., Gd, B, etc.). The nuclear fuel assay system 800 may be used to determine a mass of the nuclear fuel material within the nuclear fuel assembly 802 thereof in a manner substantially similar to that previously described with respect to the nuclear fuel assay system 100 shown in FIG. 1.

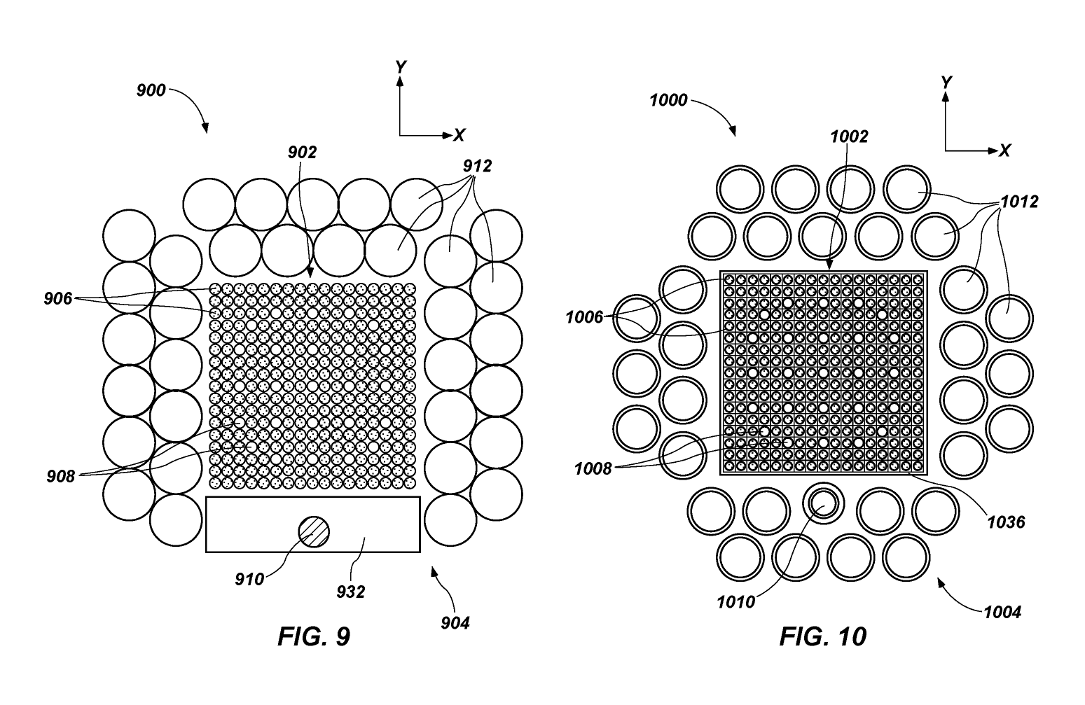

FIG. 9 illustrates a top-down view of a nuclear fuel assay system 900, in accordance with another embodiment of the disclosure. As shown in FIG. 9, the nuclear fuel assay system 900 is similar to the nuclear fuel assay system 300 shown in FIG. 3, except that individual sides of the nuclear fuel assembly 902 having pressurized ⁴He scintillation detectors 912 laterally adjacent thereto may exhibit multiple (e.g., more than one), laterally adjacent lines (e.g., multiple, laterally adjacent lines each extending in the X-direction, the Y-direction, or a combination thereof) of the pressurized ⁴He scintillation detectors 912 laterally proximate thereto. The pressurized ⁴He scintillation detectors 912 within a given line may be substantially aligned with each other of the pressurized ⁴He scintillation detectors 912 within the given line, or at least one of the pressurized ⁴He scintillation detectors 912 within the given line may be unaligned with at least one other of the pressurized ⁴He scintillation detectors 912 within the given line. In addition, as shown in FIG. 9, pressurized ⁴He scintillation detectors 912 within different laterally adjacent lines than one another may be may be offset from one another such that centers of adjacent ⁴He scintillation detectors 912 within the different laterally adjacent lines are unaligned with one another in the X-direction and/or the Y-direction. Each of the lines of the pressurized ⁴He scintillation detectors 912 may independently include any desired quantity and spacing of the pressurized ⁴He scintillation detectors 912. Surrounding sides of the nuclear fuel assembly 902 with multiple, laterally adjacent lines of the pressurized ⁴He scintillation detectors 912 may increase the probability that neutrons emitted from the nuclear fuel material of the nuclear-fuel-loaded structures 906 of the nuclear fuel assembly 902 will be detected by the pressurized ⁴He scintillation detectors 912 of the neutron collar 904. For example, including more than one line (e.g., more than one row, more than one column, etc.) of the pressurized ⁴He scintillation detectors 912 proximate a given side of the nuclear fuel assembly 902 may reduce the risk of neutrons traveling past (e.g., bypassing) the pressurized ⁴He scintillation detectors 912 without being detected. The nuclear fuel assay system 900 may be used to determine a mass of the nuclear fuel material within the nuclear fuel assembly 902 thereof in a manner substantially similar to that previously described with respect to the nuclear fuel assay system 100 shown in FIG. 1.

FIG. 10 illustrates a top-down view of a nuclear fuel assay system 1000, in accordance with another embodiment of the disclosure. As shown in FIG. 10, the neutron collar 1004 of the nuclear fuel assay system 1000 includes pressurized ⁴He scintillation detectors 1012 surrounding each of the sides of the nuclear fuel assembly 1002, and at least one neutron source 1010 positioned laterally proximate at least one side of the nuclear fuel assembly 1002 and laterally intervening between the side of the nuclear fuel assembly 1002 and at least some of the pressurized ⁴He scintillation detectors 1012 surrounding the side of the nuclear fuel assembly 1002. The neutron collar 1004 also includes at least one filter structure 1036 surrounding one or more (e.g., each) of the sides of the nuclear fuel assembly 1002. The filter structure 1036, which may have a material composition and function substantially similar to that of the filter structure 636 previously described in relation to FIG. 6, may laterally intervene between the nuclear fuel assembly 1002 and each of the neutron source 1010 and the pressurized ⁴He scintillation detectors 1012. The neutron source 1010 may be free of (e.g., absent) a moderator structure therearound, and multiple lines (e.g., multiple lines extending in the X-direction, the Y-direction, or a combination thereof) of the ⁴He scintillation detectors 1012 may surround one or more (e.g., each) of the sides of the nuclear fuel assembly 1002. The unmoderated neutron source 1010 may permit relatively higher energy neutrons emitted therefrom to penetrate more deeply and uniformly into the nuclear fuel assembly 1002, and the multiple lines (e.g., multiple rows, multiple columns, etc.) of the pressurized ⁴He scintillation detectors 1012 surrounding the sides of the nuclear fuel assembly 1002 may increase the probability of that neutrons emitted from the nuclear fuel material of the nuclear-fuel-loaded structures 1006 of the nuclear fuel assembly 1002 will be detected. In additional embodiments, a reflective structure may be positioned laterally outwardly adjacent the neutron source 1010, and may laterally intervene between the neutron source 1010 and ⁴He scintillation detectors 1012 laterally outwardly proximate the neutron source 1010. The reflective structure may, for example, reduce the occurrence of neutron accidentals during use and operation of the nuclear fuel assay system 1000, and may also direct neutrons emitted from the neutron source 1010 that may otherwise (i.e., in the absence of the reflective structure) travel away from the nuclear fuel assembly 1002 into the nuclear fuel assembly 1002. The nuclear fuel assay system 1000 may be used to determine a mass of the nuclear fuel material within the nuclear fuel assembly 1002 thereof in a manner substantially similar to that previously described with respect to the nuclear fuel assay system 100 shown in FIG. 1.

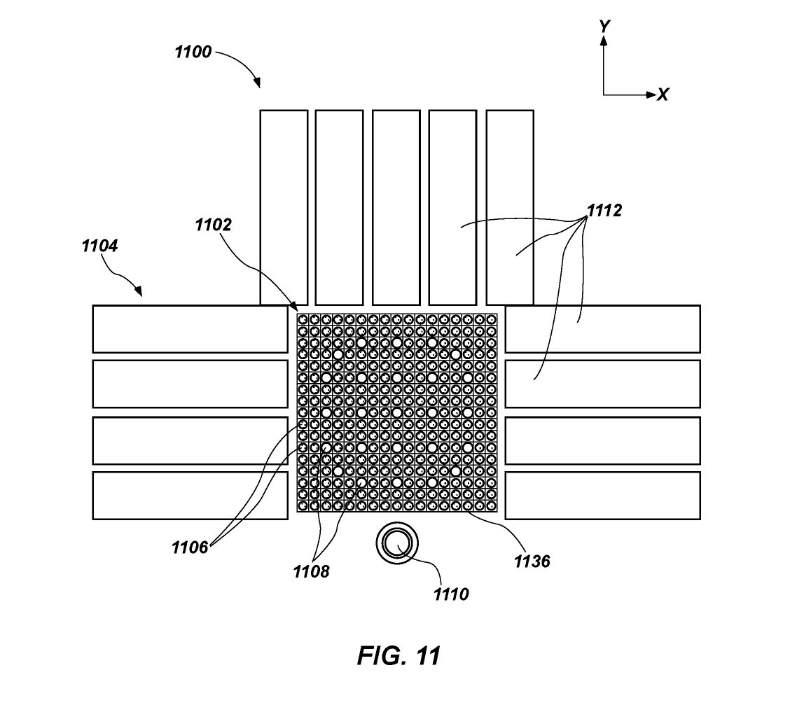

FIG. 11 illustrates a top-down view of a nuclear fuel assay system 1100, in accordance with another embodiment of the disclosure. As shown in FIG. 11, the neutron collar 1104 of the nuclear fuel assay system 1100 includes pressurized ⁴He scintillation detectors 1112 surrounding less than all of the sides of the nuclear fuel assembly 1102, and a neutron source 1110 proximate a side of the nuclear fuel assembly 1102 not surrounded by the pressurized ⁴He scintillation detectors 1112. The neutron collar 1104 also includes at least one filter structure 1136 surrounding one or more (e.g., each) of the sides of the nuclear fuel assembly 1102. The filter structure 1136, which may have a material composition and function substantially similar to that of the filter structure 636 previously described in relation to FIG. 6, may laterally intervene between the nuclear fuel assembly 1102 and each of the neutron source 1110 and the pressurized ⁴He scintillation detectors 1012. As shown in FIG. 11, the pressurized ⁴He scintillation detectors 1112 may be oriented perpendicular to the nuclear fuel assembly 1102. The perpendicular orientation of the pressurized ⁴He scintillation detectors 1112 may, for example, permit a relatively greater number of ⁴He scintillation detectors 1112 to be provided laterally proximate the nuclear fuel assembly 1102 at substantially the same, predetermined lateral distance from the nuclear fuel assembly 1102 by enabling multiple tiers of the perpendicularly-oriented, pressurized ⁴He scintillation detectors 1112 to be longitudinally stacked adjacent the sides of the nuclear fuel assembly 1102. The unmoderated neutron source 1110 may permit relatively higher energy neutrons emitted therefrom to penetrate more deeply and uniformly into the nuclear fuel assembly 1102, and multiple longitudinal tiers of perpendicularly-oriented pressurized ⁴He scintillation detectors 1112 surrounding the sides of the nuclear fuel assembly 1102 may increase the probability of that neutrons emitted from the nuclear fuel material of the nuclear-fuel-loaded structures 1106 of the nuclear fuel assembly 1102 will be detected. The nuclear fuel assay system 1100 may be used to determine a mass of the nuclear fuel material within the nuclear fuel assembly 1102 thereof in a manner substantially similar to that previously described with respect to the nuclear fuel assay system 100 shown in FIG. 1.

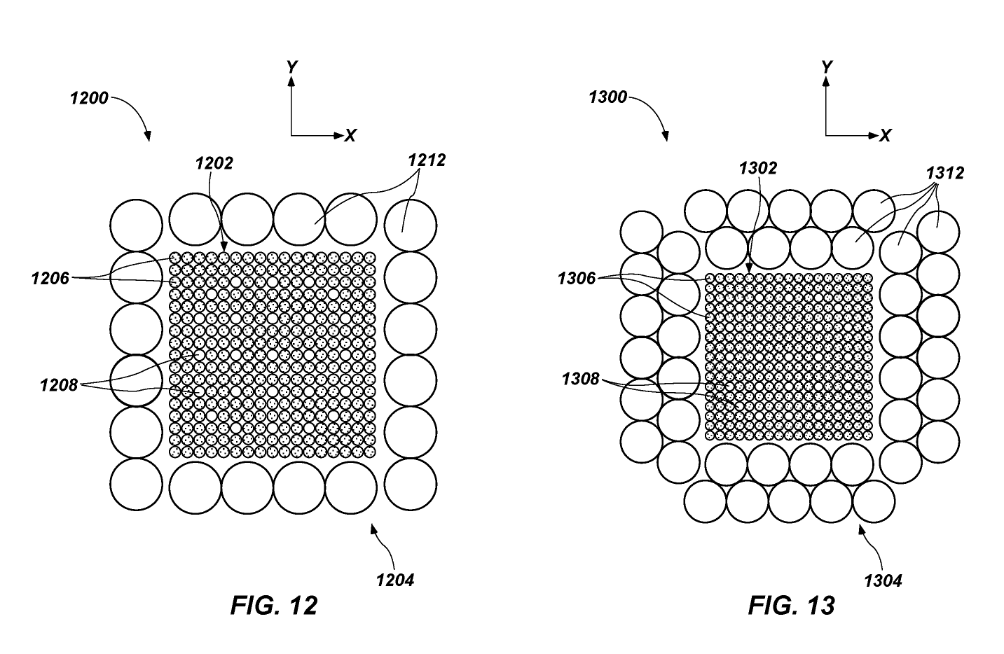

FIG. 12 illustrates a top-down view of a nuclear fuel assay system 1200, in accordance with another embodiment of the disclosure. As shown in FIG. 12, the neutron collar 1204 of the nuclear fuel assay system 1200 may exhibit a passive configuration including pressurized ⁴He scintillation detectors 1212 positioned adjacent one or more (e.g., each) of the sides of the nuclear fuel assembly 1202, but not including a neutron source (i.e., a neutron source is omitted from the neutron collar 1204). The passive configuration of the neutron collar 1204 may, for example, be utilized in embodiments wherein the nuclear fuel structures of the nuclear-fuel-loaded structures 1206 of the nuclear fuel array 1202 comprise a nuclear fuel material exhibiting a sufficiently high rate of spontaneous fission to determine the mass of the nuclear fuel material without the use of interrogating radiation. For example, the nuclear fuel structures may be formed of and include one or more of plutonium-240 (²⁴⁰Pu), plutonium-238 (²³⁸Pu), plutonium-241 (²⁴¹Pu), plutonium-242 (²⁴²Pu), a mixed oxide (MOX) including a mixture of one or more of the foregoing plutonium isotopes and one or more uranium isotopes (e.g., ²³⁵U, ²³⁸U, uranium-234 (²³⁴U), uranium-236 (²³⁶U), etc.), other plutonium isotopes (e.g., ²³⁹Pu), and/or other radioactive isotopes (e.g., ²⁴¹Am). Optionally, the nuclear fuel structures of one or more of the nuclear-fuel-loaded fuel-loaded structures 1206 may also include at least one burnable neutron poison, such as one or more of Gd and B. By way of non-limiting example, nuclear fuel structures of at least a portion of the nuclear-fuel-loaded structures 1206 may include from about five (5) wt % Gd to about twelve (12) wt % Gd.

As shown in FIG. 12, the ⁴He scintillation detectors 1212 may be oriented in parallel to the nuclear fuel assembly 1202. In some embodiments, each of the sides of the nuclear fuel assembly 1202 exhibits pressurized ⁴He scintillation detectors 1212 laterally adjacent thereto. In addition, sides of the nuclear fuel assembly 1202 having the ⁴He scintillation detectors 1212 laterally adjacent thereto may each exhibit a single (e.g., only one) line (e.g., a single line extending in the X-direction, the Y-direction, or a combination thereof) of the pressurized ⁴He scintillation detectors 1212 laterally adjacent thereto. The pressurized ⁴He scintillation detectors 1212 within a given line may be substantially aligned with each other of the pressurized ⁴He scintillation detectors 1212 within the given line, or at least one of the pressurized ⁴He scintillation detectors 1212 within the given line may be unaligned with at least one other of the pressurized ⁴He scintillation detectors 1212 within the given line. Each line of the pressurized ⁴He scintillation detectors 1212 may independently exhibit any desired quantity and spacing of the pressurized ⁴He scintillation detectors 1212 therein that facilitates the efficient detection of fast neutrons produced by the nuclear fuel assembly 1202.

During use and operation of the nuclear fuel assay system 1200, the nuclear fuel material of the nuclear-fuel-loaded structures 1206 of the nuclear fuel assembly 1202 may undergo spontaneous fission to produce fast neutrons. The fast neutrons may be received by and interact with the pressurized ⁴He scintillation detectors 1212 to produce outputs (e.g., TTL outputs) that may be analyzed (e.g., through one or more computer-numerically-assisted processes) to determine the mass of the nuclear fuel material within the nuclear fuel assembly 1202 in a manner substantially similar to that previously described with respect to the nuclear fuel assay system 100 shown in FIG. 1.

FIG. 13 illustrates a top-down view of a nuclear fuel assay system 1300, in accordance with another embodiment of the disclosure. As shown in FIG. 13, the nuclear fuel assay system 1300 is similar to the nuclear fuel assay system 1200 shown in FIG. 12, except that individual sides of the nuclear fuel assembly 1302 may exhibit multiple, laterally adjacent lines (e.g., multiple, laterally adjacent lines extending in the X-direction, the Y-direction, or a combination thereof) of the ⁴He scintillation detectors 1312 laterally proximate thereto. The pressurized ⁴He scintillation detectors 1312 within a given line may be substantially aligned with each other of the pressurized ⁴He scintillation detectors 1312 within given line, or at least one of the pressurized ⁴He scintillation detectors 1312 within the given line may be unaligned with at least one other of the pressurized ⁴He scintillation detectors 1312 within the given line. In addition, pressurized ⁴He scintillation detectors 1312 within laterally adjacent, similarly oriented lines (e.g., laterally adjacent rows, laterally adjacent columns, etc.) may be may be offset (e.g., skewed) from one another such that centers of adjacent ⁴He scintillation detectors 1312 within different laterally adjacent lines than one another are unaligned with one another in the X-direction and/or the Y-direction. Each of the multiple lines of the pressurized ⁴He scintillation detectors 1312 may independently include any desired quantity and spacing of the pressurized ⁴He scintillation detectors 1312. The nuclear fuel assay system 1300 may be used to determine a mass of the nuclear fuel material within the nuclear fuel assembly 1302 thereof in a manner substantially similar to that previously described with respect to the nuclear fuel assay system 1200 shown in FIG. 12.

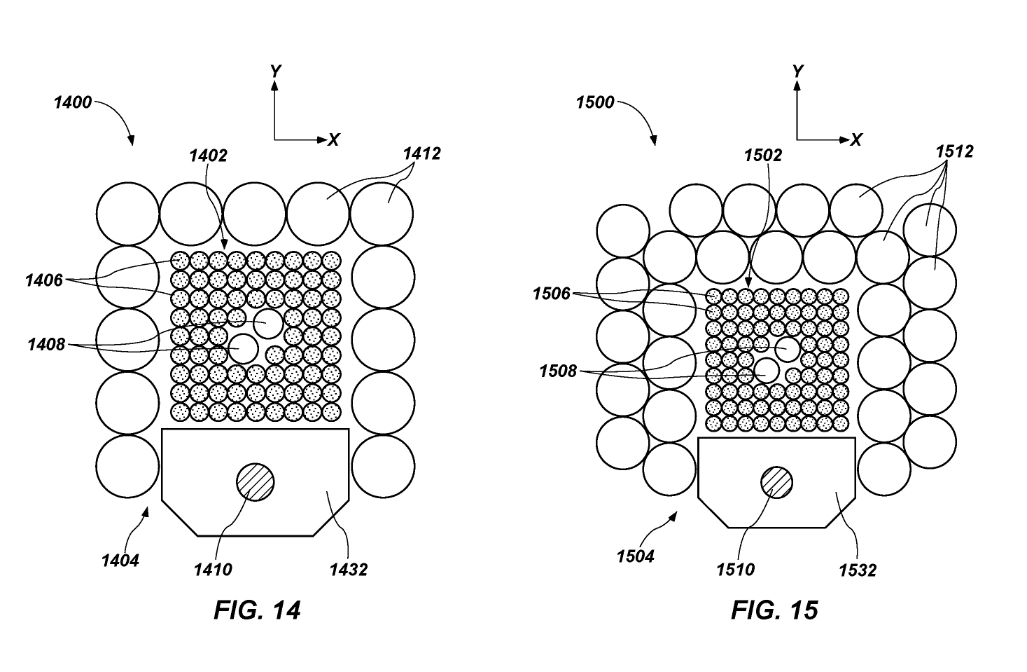

FIG. 14 illustrates a top-down view of a nuclear fuel assay system 1400, in accordance with another embodiment of the disclosure. As shown in FIG. 14, nuclear fuel assay system 1400 includes a nuclear fuel assembly 1402, and a neutron collar 1404 surrounding sides of the nuclear fuel assembly 1402. The nuclear fuel assembly 1402 may be similar to the nuclear fuel assembly 102 previously described in relation to FIG. 1, except that the nuclear fuel assembly 1402 may exhibit a conventional BWR nuclear fuel assembly configuration instead of the conventional PWR nuclear fuel assembly configuration of the nuclear fuel assembly 102 shown in FIG. 1. For example, the nuclear fuel assembly 1402 may include nuclear-fuel-loaded structures 1406 surrounding empty structures 1408 having relatively larger diameters than the nuclear-fuel-loaded structures 1406. As shown in FIG. 14, in some embodiments, the nuclear fuel assembly 1402 exhibits a square lateral peripheral shape and includes seventy-four (74) nuclear-fuel-loaded structures 1406 surrounding two (2) empty structures 1408. In additional embodiments, the nuclear fuel assembly 1402 may exhibit a different configuration, such a configuration exhibiting one or more of a different lateral peripheral shape (e.g., a non-square lateral peripheral shape, such as a generally circular lateral peripheral shape), a different quantity of the nuclear-fuel-loaded structures 1406 (e.g., less than seventy-four (74) of the nuclear-fuel-loaded structures 1406, greater than seventy-four (74) of the nuclear-fuel-loaded structures 1406), a different quantity of the empty structures 1408 (e.g., less than two (2) of the empty structures 1408, greater than two (2) of the empty structures 1408), and a different arrangement of the nuclear-fuel-loaded structures 1406 relative to the empty structures 1408. The nuclear-fuel-loaded structures 1406 and the empty structures 1408 may have material compositions respectively substantially similar to those of the nuclear-fuel-loaded structures 106 and the empty structures 108 previously described with respect to be FIG. 1.

As shown in FIG. 14, the neutron collar 1404 of the nuclear fuel assay system 1400 may exhibit an active configuration including at least one neutron source 1410 positioned adjacent a side of the nuclear fuel assembly 1402, and pressurized ⁴He scintillation detectors 1412 positioned adjacent additional sides of the nuclear fuel assembly 1402. The neutron collar 1404 also includes a moderator structure 1432 at least partially (e.g., completely) surrounding the neutron source 1410. The neutron source 1410 and the pressurized ⁴He scintillation detectors 1412 may respectively have components, component arrangements, component material compositions, and functions substantially similar to those of the neutron source 110 and the pressurized ⁴He scintillation detectors 112 previously described with respect to FIG. 1. In addition, the moderator structure 1432 may have a material composition and function substantially similar to that of the moderator structure 332 previously described in relation to FIG. 3. Furthermore, as shown in FIG. 14, sides of the nuclear fuel assembly 1402 having the pressurized ⁴He scintillation detectors 1412 laterally adjacent thereto may each exhibit a single (e.g., only one) line (e.g., a single line extending in the X-direction, the Y-direction, or a combination thereof) of the pressurized ⁴He scintillation detectors 1412 laterally adjacent thereto. The pressurized ⁴He scintillation detectors 1412 within a given line may be substantially aligned with each other of the pressurized ⁴He scintillation detectors 1412 within the given line, or at least one of the pressurized ⁴He scintillation detectors 1412 within the given line may be unaligned with at least one other of the pressurized ⁴He scintillation detectors 1412 within the given line. The neutron collar 1404 may exhibit any desired quantity and spacing of the pressurized ⁴He scintillation detectors 1412 and any desired quantity and spacing of neutron source(s) 1410 that facilitate the efficient detection of fast neutrons produced by the nuclear fuel assembly 1402.

The nuclear fuel assay system 1400 may be used to determine a mass of the nuclear fuel material within the nuclear fuel assembly 1402 thereof in a manner substantially similar to that previously described with respect to the nuclear fuel assay system 100 shown in FIG. 1.

FIG. 15 illustrates a top-down view of a nuclear fuel assay system 1500 in accordance with another embodiment of the disclosure. As shown in FIG. 15, the nuclear fuel assay system 1500 is similar to the nuclear fuel assay system 1400 shown in FIG. 14, except that individual sides of the nuclear fuel assembly 1502 may exhibit multiple, laterally adjacent lines of the pressurized ⁴He scintillation detectors 1512 laterally proximate thereto. The pressurized ⁴He scintillation detectors 1512 within a given line may be substantially aligned with each other of the pressurized ⁴He scintillation detectors 1512 within given line, or at least one of the pressurized ⁴He scintillation detectors 1512 within the given line may be unaligned with at least one other of the pressurized ⁴He scintillation detectors 1512 within the given line. In addition, pressurized ⁴He scintillation detectors 1512 within laterally adjacent, similarly oriented lines (e.g., laterally adjacent rows, laterally adjacent columns, etc.) may be may be offset (e.g., skewed) from one another such that centers of adjacent pressurized ⁴He scintillation detectors 1512 within different lines than one another are unaligned with one another in the X-direction and/or the Y-direction. Each of the multiple lines of the pressurized ⁴He scintillation detectors 1512 may independently include any desired quantity and spacing of the pressurized ⁴He scintillation detectors 1512. The nuclear fuel assay system 1500 may be used to determine a mass of the nuclear fuel material within the nuclear fuel assembly 1502 thereof in a manner substantially similar to that previously described with respect to the nuclear fuel assay system 100 shown in FIG. 1.

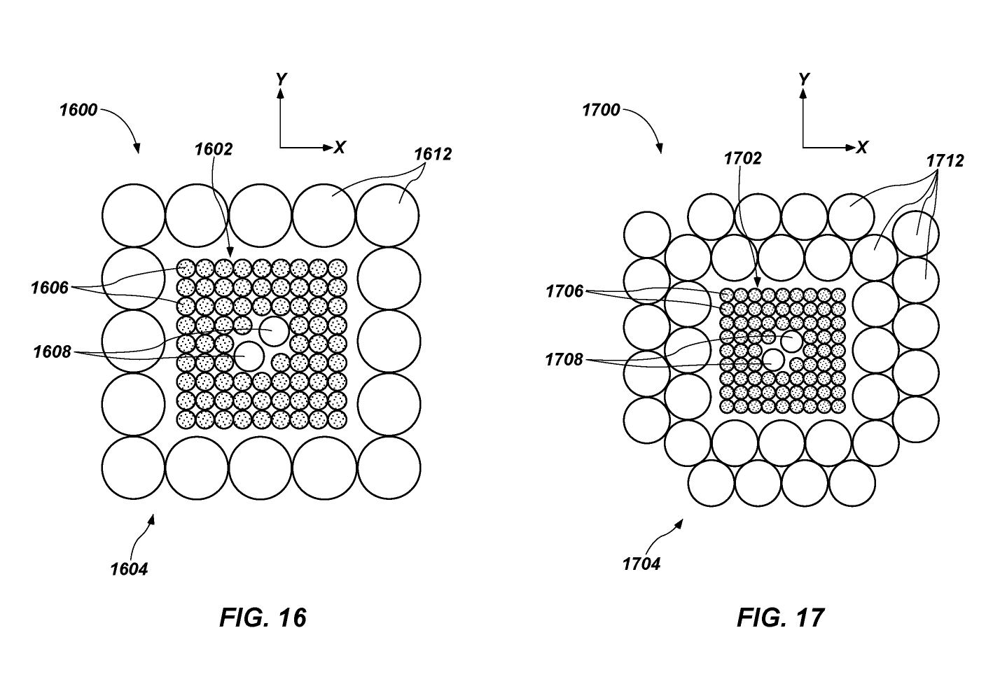

FIG. 16 illustrates a top-down view of a nuclear fuel assay system 1600 in accordance with another embodiment of the disclosure. As shown in FIG. 16, the neutron collar 1604 of the nuclear fuel assay system 1600 may exhibit a passive configuration including pressurized ⁴He scintillation detectors 1612 positioned adjacent one or more (e.g., each) of the sides of the nuclear fuel assembly 1602, but not including a neutron source (i.e., a neutron source is omitted from the neutron collar 1604). The passive configuration of the neutron collar 1604 may, for example, be utilized in embodiments wherein nuclear fuel structures of the nuclear-fuel-loaded structures 1606 of the nuclear fuel assembly 1602 comprise nuclear fuel material exhibiting a sufficiently high rate of spontaneous fission to determine the mass of the nuclear fuel material without the use of interrogating radiation. The nuclear fuel structures of the nuclear-fuel-loaded structures 1606 may, for example, have material compositions substantially similar to those of the nuclear fuel structures of the nuclear-fuel-loaded structures 1206 previously described with respect to FIG. 12.

As shown in FIG. 16, the pressurized ⁴He scintillation detectors 1612 may be oriented in parallel to the nuclear fuel assembly 1602. In some embodiments, each of the sides of the nuclear fuel assembly 1602 exhibits pressurized ⁴He scintillation detectors 1612 laterally adjacent thereto. In addition, sides of the nuclear fuel assembly 1602 having the pressurized ⁴He scintillation detectors 1612 laterally adjacent thereto may each exhibit a single (e.g., only one) line of the pressurized ⁴He scintillation detectors 1612 laterally adjacent thereto. The pressurized ⁴He scintillation detectors 1612 within a given line may be substantially aligned with each other of the pressurized ⁴He scintillation detectors 1612 within the given line, or at least one of the pressurized ⁴He scintillation detectors 1612 within the given line may be unaligned with at least one other of the pressurized ⁴He scintillation detectors 1612 within the given line. Each line of the pressurized ⁴He scintillation detectors 1612 may exhibit independently exhibit any desired quantity and spacing of the pressurized ⁴He scintillation detectors 1612 therein that facilitate the efficient detection of fast neutrons produced by the nuclear fuel assembly 1602.

The nuclear fuel assay system 1600 may be used to determine a mass of the nuclear fuel material within the nuclear fuel assembly 1602 thereof in a manner substantially similar to that previously described with respect to the nuclear fuel assay system 1200 shown in FIG. 12.

FIG. 17 illustrates a top-down view of a nuclear fuel assay system 1700 in accordance with another embodiment of the disclosure. As shown in FIG. 17, the nuclear fuel assay system 1700 is similar to the nuclear fuel assay system 1600 shown in FIG. 16, except that individual sides of the nuclear fuel assembly 1702 may exhibit multiple, laterally adjacent lines of the pressurized ⁴He scintillation detectors 1712 laterally proximate thereto. The pressurized ⁴He scintillation detectors 1712 within a given line may be substantially aligned with each other of the pressurized ⁴He scintillation detectors 1712 within given line, or at least one of the pressurized ⁴He scintillation detectors 1712 within the given line may be unaligned with at least one other of the pressurized ⁴He scintillation detectors 1712 within the given line. In addition, pressurized ⁴He scintillation detectors 1712 within laterally adjacent, similarly oriented lines (e.g., laterally adjacent rows, laterally adjacent columns, etc.) may be may be offset (e.g., skewed) from one another such that centers of adjacent pressurized ⁴He scintillation detectors 1712 within different laterally adjacent lines than one another are unaligned with one another in the X-direction and/or the Y-direction. Each of the multiple lines of the pressurized ⁴He scintillation detectors 1712 may independently include any desired quantity and spacing of the pressurized ⁴He scintillation detectors 1712. The nuclear fuel assay system 1700 may be used to determine a mass of the nuclear fuel material within the nuclear fuel assembly 1702 thereof in a manner substantially similar to that previously described with respect to the nuclear fuel assay system 1200 shown in FIG. 12.

The following examples serve to explain embodiments of the disclosure in more detail. The examples are not to be construed as being exhaustive or exclusive as to the scope of the disclosure.

### EXAMPLES

### Example 1

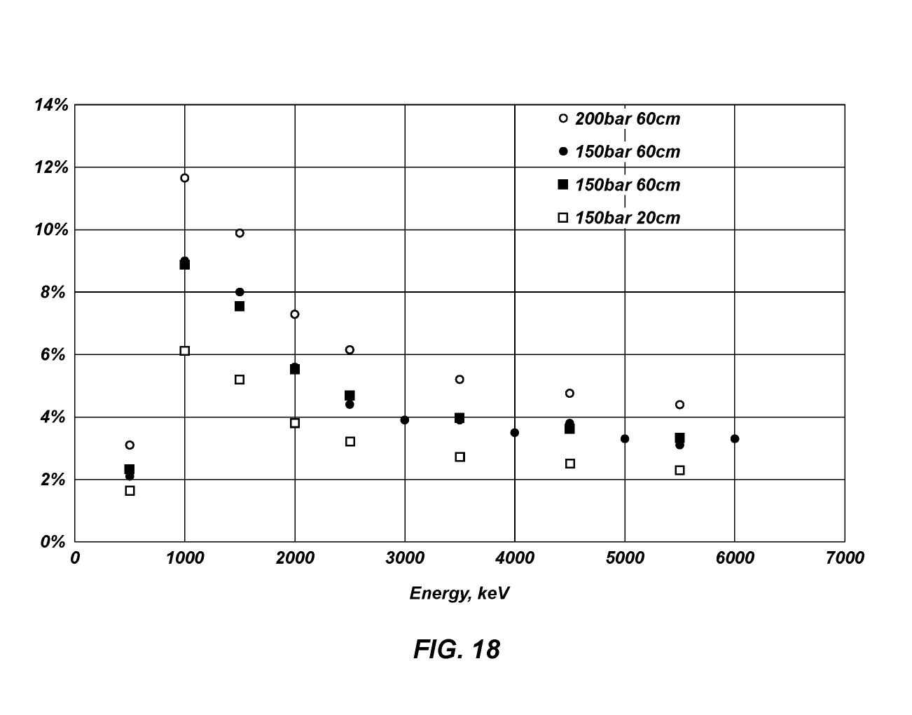

Individual pressurized ⁴He scintillation detector responses were computer-numerically analyzed for different pressurized ⁴He scintillation detectors employing different operating pressures (e.g., ⁴He gas pressures) and/or active (e.g., internal chamber) lengths. Four (4) different pressurized ⁴He scintillation detectors were modeled to evaluate the estimated probabilities (e.g., estimated percentage chances) that neutrons at different energy levels would be detected by the each of the different pressurized ⁴He scintillation detectors. A first pressurized ⁴He scintillation detector was modeled based on a ⁴He gas pressure of 150 bar, and an active length of 20 centimeters (cm). Second and third pressurized ⁴He scintillation detectors were modeled based on a ⁴He gas pressure of 150 bar, and an active length of 60 cm. A fourth pressurized ⁴He scintillation detector was modeled based on a ⁴He gas pressure of 200 bar, and an active length of 60 centimeters (cm). Beyond the differences in operating pressure and/or active length, the operating parameters, features (e.g., components, such as light sensors), and feature-related estimations (e.g., light sensor estimations, such as efficiency estimations, dead time estimations, recovery time estimations, timing estimations, etc.) of the different pressurized ⁴He scintillation detectors were identical to one another. FIG. 18 is a graph showing the results of the computer-numerical analysis. In FIG. 18, the X-axis represents neutron energy, and the Y-axis represents the estimated percentage chance of neutron detection. The plots for the different pressurized ⁴He scintillation detectors analyzed show that pressurized ⁴He scintillation detectors are able to detect fast neutrons at different efficiencies at least partially depending on the energy levels of the neutrons being detected and on the operating pressure and active length of the pressurized ⁴He scintillation detector. The results validate that employing one or more pressurized ⁴He scintillation detectors in an assembly (e.g., neutron collar) surrounding a nuclear fuel material would facilitate the detection of fast neutrons emitted from the nuclear fuel material.

### Example 2

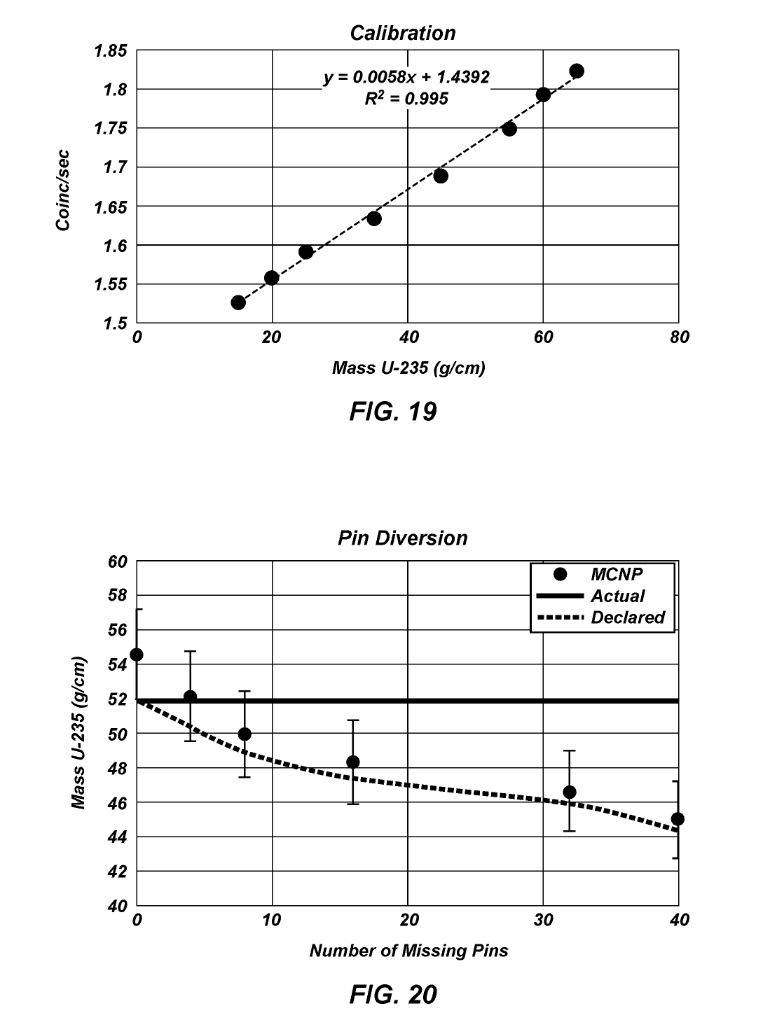

The configuration of the nuclear fuel assay system 800 shown in FIG. 8 was subjected to computer-numeral analysis to develop a calibration curve for coincidence rate (e.g., number of neutron pairs (e.g., doubles) detected per second) versus mass of ²³⁵U included in ²³⁵U-loaded structures (e.g., the nuclear-fuel-loaded structures 806 shown in FIG. 8) of the nuclear fuel assembly (e.g., the nuclear fuel assembly 802 shown in FIG. 8). FIG. 19 is a graph showing the resulting calibration curve. The calibration curve shows that as ²³⁵U mass increases the coincidence rate also increases, and that the relationship between the ²³⁵U mass and the coincidence rate is substantially linear.

### Example 3

The configuration of the nuclear fuel assay system 800 shown in FIG. 8 was subjected to computer-numeral analysis to evaluate the ability of the configuration to determine a quantity of missing (e.g., diverted) ²³⁵U-loaded structures (e.g., the nuclear-fuel-loaded structures 806 shown in FIG. 8) in the nuclear fuel assembly (e.g., the nuclear fuel assembly 802 shown in FIG. 8) relative to a declared quantity of ²³⁵U-loaded structures in the nuclear fuel assembly based on a determined mass of ²³⁵U included in ²³⁵U-loaded structures. FIG. 20 is a graph showing the results of the analysis. The results indicate that, when accounting for estimated error margins, the nuclear fuel assay system configuration shown in FIG. 8 is able to identify if greater than or equal to about ten (10) ²³⁵U-loaded structures are missing from the nuclear fuel assembly.

### Example 4

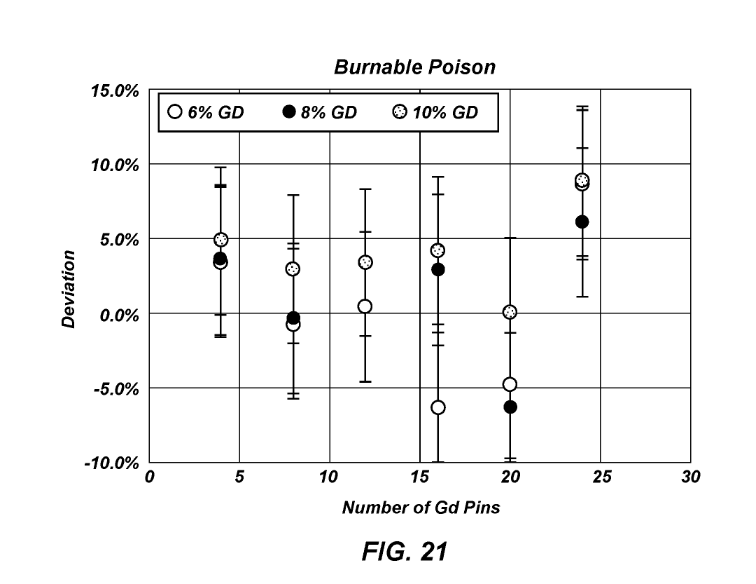

The configuration of the nuclear fuel assay system 800 shown in FIG. 8 was subjected to computer-numeral analysis to estimate deviations from actual ²³⁵U mass in the nuclear fuel assembly (e.g., the nuclear fuel assembly 802 shown in FIG. 8) that may be observed if at least some ²³⁵U-loaded structures thereof (e.g., the nuclear-fuel-loaded structures 806 shown in FIG. 8) include some amount of burnable neutron poison (e.g., Gd). The analysis evaluated different amounts (e.g., between 6 wt % and 10 wt %) of Gd in different quantities (e.g., between four (4) and twenty-four (24)) of ²³⁵U-loaded structures. FIG. 21 is a graph showing the results of the analysis. The results show where corrective adjustments to determined ²³⁵U mass may be made to account for underestimations in ²³⁵U mass resulting from the presence of Gd in some of the ²³⁵U-loaded structures.

While the disclosure is susceptible to various modifications and alternative forms, specific embodiments have been shown by way of example in the drawings and have been described in detail herein. However, the disclosure is not limited to the particular forms disclosed. Rather, the disclosure is to cover all modifications, equivalents, and alternatives falling within the scope of the following appended claims and their legal equivalent. For example, elements and features disclosed in relation to one embodiment may be combined with elements and features disclosed in relation to other embodiments of the disclosure.

What is claimed is:

1. A nuclear fuel assay system, comprising:
a nuclear fuel assembly comprising structures containing nuclear fuel; and
a neutron collar surrounding sides of the nuclear fuel assembly and comprising pressurized ⁴He scintillation detectors.

2. The nuclear fuel assay system of claim 1, wherein the structures of the nuclear fuel assembly each independently contain fresh nuclear fuel or partially spent nuclear fuel.

3. The nuclear fuel assay system of claim 1, wherein the pressurized ⁴He scintillation detectors each independently comprise:
a housing structure filled with ⁴He gas having a pressure greater than or equal to about 150 bar; and
at least one light sensor configured and positioned to detect radiation resulting from elastic scattering of fast neutrons from the nuclear fuel within the ⁴He gas.

4. The nuclear fuel assay system of claim 1, wherein the neutron collar further comprises at least one neutron source configured and positioned to direct neutrons into the nuclear fuel assembly to induce fission in the nuclear fuel.

5. The nuclear fuel assay system of claim 4, wherein the pressurized ⁴He scintillation detectors are positioned laterally adjacent at least one of the sides of the nuclear fuel assembly and the at least one neutron source is positioned laterally adjacent at least one other of the sides of the nuclear fuel assembly.

6. The nuclear fuel assay system of claim 4, wherein the at least one neutron source comprises a plurality of neutron sources, at least one of the plurality of neutron sources positioned laterally adjacent a same side of the nuclear fuel assembly as at least some of the pressurized ⁴He scintillation detectors.

7. The nuclear fuel assay system of claim 4, wherein the neutron collar further comprises at least one moderator structure at least partially surrounding the at least one neutron source, the at least one moderator structure comprising a material formulated to scatter and lower energy levels of neutrons emitted by the neutron source.

8. The nuclear fuel assay system of claim 4, wherein the neutron collar further comprises at least one filter structure laterally intervening between the at least one neutron source and the nuclear fuel assembly, the at least one filter structure comprising a material formulated to prevent thermal neutrons and epithermal neutrons from passing therethrough.

9. The nuclear fuel assay system of claim 4, wherein the neutron collar further comprises at least one reflective structure positioned laterally outwardly adjacent the at least one neutron source relative to a location of the nuclear fuel assembly, the at least one reflective structure comprising a material formulated to scatter neutrons emitted by the neutron source.

10. The nuclear fuel assay system of claim 1, wherein the neutron collar further comprises at least one reflective structure partially surrounding sides of one or more of the pressurized ⁴He scintillation detectors, the at least one reflective structure comprising a material formulated to scatter fast neutrons emitted by the nuclear fuel.

11. The nuclear fuel assay system of claim 1, wherein the pressurized ⁴He scintillation detectors laterally surround each side of the nuclear fuel assembly.

12. The nuclear fuel assay system of claim 1, wherein at least a portion of the pressurized ⁴He scintillation detectors are arranged in multiple, laterally adjacent lines surrounding at least one of the sides of the nuclear fuel assembly.

13. The nuclear fuel assay system of claim 1, wherein at least a portion of the pressurized ⁴He scintillation detectors are oriented perpendicular to the nuclear fuel assembly.

14. A system for assaying nuclear fuel, comprising:
a nuclear fuel assembly comprising nuclear-fuel-loaded structures each independently comprising:
a cladding structure; and
a nuclear fuel material within the cladding structure and comprising one or more of uranium and plutonium; and
a neutron collar laterally surrounding sides of the nuclear fuel assembly and comprising pressurized ⁴He scintillation detectors configured and positioned to receive fast neutrons from the nuclear fuel assembly, each of the pressurized ⁴He scintillation detectors independently comprising:
a housing structure filled with ⁴He gas having a pressure greater than or equal to about 150 bar; and
at least one sensor configured and positioned to detect radiation resulting from elastic scattering of the fast neutrons within the ⁴He gas.

15. The system of claim 14, wherein the nuclear fuel material comprises unspent nuclear fuel material.

16. The system of claim 14, wherein:
the nuclear fuel material of at least one of the nuclear-fuel-loaded structures of the nuclear fuel assembly comprises one or more of ²³⁵U, ^{238U,} and ²³⁹Pu; and
the neutron collar further comprises at least one neutron source configured and positioned to produce and direct neutrons into the nuclear fuel material to induce fission therein.

17. The system of claim 16, wherein the neutron collar further comprises one or more of:
at least one moderator structure completely surrounding at least one neutron source, the at least one moderator structure comprising a polyethylene material formulated to scatter and lower energy levels of neutrons emitted by the neutron source;
at least one filter structure at least partially surrounding the sides of the nuclear fuel assembly, the at least one filter structure comprising at least one material formulated to prevent thermal neutrons and epithermal neutrons from passing therethrough; and
at least one reflective structure comprising a polyethylene material outwardly laterally surrounding one or more of the at least one neutron source and at least a portion of the pressurized ⁴He scintillation detectors.

18. The system of claim 14, wherein:
the nuclear fuel material of at least one of the nuclear-fuel-loaded structures of the nuclear fuel assembly comprises one or more of ⁴²⁰pu, ²³⁸Pu, ²⁴¹Pu, and ²⁴²Pu; and
the pressurized ⁴He scintillation detectors of the neutron collar laterally surround each of the sides of the nuclear fuel assembly.

19. The system of claim 14, wherein the nuclear fuel material of at least one of the nuclear-fuel-loaded structures of the nuclear fuel assembly further comprises a burnable neutron poison.

20. A method of quantifying nuclear material, comprising:
surrounding an assembly comprising structures loaded with nuclear fuel with a neutron collar comprising an array of pressurized ⁴He scintillation detectors;
detecting fast neutrons emitted from the assembly using the array of pressurized ⁴He scintillation detectors; and
determining a mass of the nuclear fuel at least partially based on the quantity of fast neutrons detected by the array of pressurized ⁴He scintillation detectors over a predetermined period of time.

21. The method of claim 20, wherein surrounding an assembly comprising structures loaded with nuclear fuel with a neutron collar comprises surround a nuclear fuel assembly loaded with one or more of unirradiated nuclear fuel and partially spent nuclear fuel with the neutron collar.

22. The method of claim 20, further comprising:
selecting the neutron collar to further comprise at least one neutron source; and
directing neutrons emitted by the at least one neutron source into the assembly to induce fission in the nuclear fuel of the structures thereof and produce at least a portion of the fast neutrons.

23. The method of claim 20, wherein detecting fast neutrons emitted from the assembly using the array of pressurized ⁴He scintillation detectors comprises detecting the fast neutrons without previously lowering energies of the fast neutrons using a moderator structure.
